(19) United States
(12) Patent Application Publication
(10) Pub. No.: US 2026/0121061 A1
(43) Pub. Date: Apr. 30, 2026

(54) SECONDARY BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Kazuya SHIMADA, Atsugi, Kanagawa (JP); Yohei MOMMA, Isehara, Kanagawa (JP); Kunihiro FUKUSHIMA, Isehara, Kanagawa (JP); Atsushi KAWATSUKI, Yokohama, Kanagawa (JP)

(21) Appl. No.: 18/555,297

(22) PCT Filed: Apr. 5, 2022
(86) PCT No.: PCT/IB2022/053134

§ 371 Date: Oct. 13, 2023

(30) Foreign Application Priority Data
Apr. 16, 2021 (JP) 2021-069767

(51) Int. Cl. H01M 4/62; B60L 50/64; H01M 4/02; H01M 4/36; H01M 4/525; H01M 50/109

(52) U.S. Cl. CPC H01M 4/628; H01M 4/366; H01M 4/525; H01M 50/109; B60L 50/64; H01M 2004/021; H01M 2004/028; H01M 2220/20

(57) ABSTRACT

A positive electrode active material that enables an increased discharge capacity retention rate of cycling performance is provided. A secondary battery includes a positive electrode pressed under a linear pressure higher than or equal to 100 kN/m and lower than or equal to 3000 kN/m and a negative electrode. When a test battery that includes the positive electrode and a negative electrode containing lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, and the discharge capacity of the battery is measured in each cycle, a discharge capacity value measured in the 50th cycle is greater than or equal to 35% and less than 100% of the maximum discharge capacity value in all the 50 cycles.

### TECHNICAL FIELD

One embodiment of the present invention relates to an object, a method, or a manufacturing method. One embodiment of the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification means all devices that include secondary batteries, and electro-optical devices that include secondary batteries, information terminal devices that include secondary batteries, and the like are all electronic devices. A secondary battery is sometimes referred to as a storage battery.

### BACKGROUND ART

In recent years, power storage devices such as secondary batteries, capacitors, air batteries, and all-solid-state batteries have been actively developed. In particular, demand for lithium-ion secondary batteries with high output and a high capacity has rapidly grown with the development of the semiconductor industry. The lithium-ion secondary batteries are essential as rechargeable energy supply sources for today's information society.

It is particularly desired that lithium-ion secondary batteries and the like of mobile electronic devices have a high discharge capacity per weight and excellent cycling performance. In order to meet such demands, positive electrode active materials in positive electrodes of secondary batteries have been actively improved (see Patent Document 1 to Patent Document 3, for example).

### REFERENCE

### Patent Document

[Patent Document 1] Japanese Published Patent Application No. 2019-179758
[Patent Document 2] International Publication WO 2020/026078 Pamphlet
[Patent Document 3] Japanese Published Patent Application No. 2020-140954

### SUMMARY OF THE INVENTION

### Problems to be Solved by the Invention

Development of positive electrode active materials used in secondary batteries has room for improvement in terms of discharge capacity, cycling performance, reliability, safety, cost, and the like.

In view of the above, an object of one embodiment of the present invention is to provide a positive electrode active material that enables an increased discharge capacity retention rate of cycling performance. Another object of one embodiment of the present invention is to provide a positive electrode active material whose crystal structure is not easily broken even when charging and discharging are repeated. Another object of one embodiment of the present invention is to provide a positive electrode active material that enables a high discharge capacity. Another object of one embodiment of the present invention is to provide a secondary battery, an electronic device, or a vehicle that includes the above positive electrode active material and has a high level of safety or high reliability.

Another object of one embodiment of the present invention is to provide a method for manufacturing a positive electrode active material, a secondary battery, an electronic device, or a vehicle.

Note that the description of these objects does not preclude the existence of other objects. These objects should be construed as being independent of one another and one embodiment of the present invention does not need to achieve all the objects. Moreover, other objects can be derived from the description of the specification, the drawings, and the claims (which are sometimes referred to as “this specification and the like”).

### Means for Solving the Problems

One embodiment of the present invention is a secondary battery that includes a positive electrode and a negative electrode. When a test battery in which the positive electrode is used as a positive electrode and a negative electrode includes lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, and the discharge capacity of the test battery is measured in each cycle, a discharge capacity value measured in the 50th cycle is greater than or equal to 35% and less than 100% of the maximum discharge capacity value in all the 50 cycles.

One embodiment of the present invention is a secondary battery that includes a positive electrode pressed under a linear pressure higher than or equal to 100 KN/m and lower than or equal to 3000 KN/m and a negative electrode. When a test battery in which the positive electrode is used as a positive electrode and a negative electrode includes lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, and a discharge capacity of the test battery is measured in each cycle, a discharge capacity value measured in the 50th cycle is greater than or equal to 35% and less than 100% of a maximum discharge capacity value in all 50 cycles.

In one embodiment of the present invention, the positive electrode preferably has an electrode density higher than or equal to 2.5 g/cc and lower than or equal to 4.5 g/cc.

One embodiment of the present invention is a secondary battery that includes a positive electrode having an electrode density higher than or equal to 2.5 g/cc and lower than or equal to 4.5 g/cc and a negative electrode. When a test battery in which the positive electrode is used as a positive electrode and a negative electrode includes lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, and a discharge capacity of the test battery is measured in each cycle, a discharge capacity value measured in the 50th cycle is greater than or equal to 35% and less than 100% of a maximum discharge capacity value in all 50 cycles.

In one embodiment of the present invention, the positive electrode preferably has a porosity higher than or equal to 8% and lower than or equal to 35%.

One embodiment of the present invention is a secondary battery that includes a positive electrode having a porosity higher than or equal to 8% and lower than or equal to 35% and a negative electrode. When a test battery in which the positive electrode is used as a positive electrode and a negative electrode includes lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, and a discharge capacity of the test battery is measured in each cycle, a discharge capacity value measured in the 50th cycle is greater than or equal to 35% and less than 100% of a maximum discharge capacity value in all 50 cycles.

One embodiment of the present invention is a secondary battery that includes a positive electrode and a negative electrode. After a test battery in which the positive electrode is used as a positive electrode and a negative electrode includes lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, the proportion of an area of a closed split observed by a cross-sectional STEM in one cross section of a positive electrode active material of the positive electrode of the test battery is lower than or equal to 0.9%.

One embodiment of the present invention is a secondary battery that includes a positive electrode pressed under a linear pressure higher than or equal to 100 KN/m and lower than or equal to 3000 KN/m and a negative electrode. After a test battery in which the positive electrode is used as a positive electrode and a negative electrode includes lithium undergoes, in an environment at higher than or equal to 25° C. and lower than or equal to 45° C., a cycling test of 50 repetitions of a cycle of charging and discharging in which, after constant current charging is performed at a charge rate of 0.5 C (1 C=200 mA/g) until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, the proportion of an area of a closed split observed by a cross-sectional STEM in one cross section of a positive electrode active material of the positive electrode of the test battery is lower than or equal to 0.9%.

In one embodiment of the present invention, the test battery preferably includes an electrolyte solution.

In one embodiment of the present invention, the test battery is preferably a coin-type half cell.

In one embodiment of the present invention, the positive electrode preferably includes a layered rock-salt positive electrode active material.

In one embodiment of the present invention, the positive electrode active material preferably includes lithium cobalt oxide.

One embodiment of the present invention is an electronic device or a vehicle that includes any of the above secondary batteries.

### Effect of the Invention

One embodiment of the present invention can provide a positive electrode active material that enables an increased discharge capacity retention rate of cycling performance. One embodiment of the present invention can provide a positive electrode active material whose crystal structure is not easily broken even when charging and discharging are repeated. One embodiment of the present invention can provide a positive electrode active material that enables a high discharge capacity. One embodiment of the present invention can provide a secondary battery, an electronic device, or a vehicle that includes the above positive electrode active material and has a high level of safety or high reliability.

One embodiment of the present invention can provide a method for manufacturing a positive electrode active material, a secondary battery, an electronic device, or a vehicle.

Note that the description of these effects does not preclude the existence of other effects. These effects should be construed as being independent of one another and one embodiment of the present invention does not need to have all the effects. Other effects can be derived from the description of the specification and the like.

### BRIEF DESCRIPTION OF THE DRAWINGS

FIG. 1 is a diagram illustrating a positive electrode active material having defects.

FIG. 2A and FIG. 2B are diagrams illustrating correlations.

FIG. 3 is a diagram illustrating a manufacturing method of a secondary battery.

FIG. 4 is a diagram illustrating a manufacturing apparatus of a secondary battery.

FIG. 5A to FIG. 5C are diagrams illustrating a manufacturing method of a secondary battery.

FIG. 6A to FIG. 6D are diagrams illustrating a manufacturing method of a secondary battery.

FIG. 7A to FIG. 7C are diagrams illustrating a manufacturing method of a positive electrode active material.

FIG. 8 is a diagram illustrating a manufacturing method of a positive electrode active material.

FIG. 9A to FIG. 9C are diagrams illustrating manufacturing methods of a positive electrode active material.

FIG. 10A to FIG. 10C2 are diagrams illustrating a positive electrode active material.

FIG. 11A to FIG. 11C2 are diagrams illustrating a positive electrode active material.

FIG. 12A to FIG. 12C are diagrams illustrating a positive electrode mixture layer.

FIG. 13A and FIG. 13B are diagrams illustrating an all-solid-state battery.

FIG. 14A and FIG. 14B are diagrams illustrating a coin-type half cell (test battery).

FIG. 15 is a diagram illustrating an assembling method of a test battery for a cycling test.

FIG. 16A to FIG. 16C are diagrams illustrating an example of a secondary battery.

FIG. 17A to FIG. 17D are diagrams illustrating an example of a secondary battery.

FIG. 18A to FIG. 18C are diagrams illustrating examples of vehicles.

FIG. 19A to FIG. 19D are diagrams illustrating examples of electronic devices.

FIG. 20A and FIG. 20B are graphs each showing a charge and discharge capacity of cycling performance (with varied measurement temperatures and charge voltages).

FIG. 21A and FIG. 21B are graphs each showing a charge and discharge capacity of cycling performance (with varied measurement temperatures and charge voltages).

FIG. 22A and FIG. 22B are graphs each showing a charge and discharge capacity of cycling performance (with varied measurement temperatures and charge voltages).

FIG. 23A and FIG. 23B are graphs each showing charge and discharge curves of cycling performance (with varied measurement temperatures and charge voltages).

FIG. 24A and FIG. 24B are graphs each showing charge and discharge curves of cycling performance (with varied measurement temperatures and charge voltages).

FIG. 25 is a graph showing charge and discharge curves of cycling performance (with varied measurement temperatures and charge voltages).

FIG. 26A and FIG. 26B are graphs each showing charge and discharge curves of cycling performance (with varied measurement temperatures and charge voltages).

FIG. 27A and FIG. 27B are graphs each showing charge and discharge curves of cycling performance (with varied measurement temperatures and charge voltages).

FIG. 28 is a graph showing charge and discharge curves of cycling performance (with varied measurement temperatures and charge voltages).

FIG. 29A and FIG. 29B are graphs each showing charge and discharge curves of cycling performance (with varied measurement temperatures and charge voltages).

FIG. 30A and FIG. 30B are graphs each showing charge and discharge curves of cycling performance (with varied measurement temperatures and charge voltages).

FIG. 31 is a graph showing charge and discharge curves of cycling performance (with varied measurement temperatures and charge voltages).

FIG. 32 is a graph showing a discharge capacity retention rate as a function of measurement temperature.

FIG. 33 is a graph showing a charge depth as a function of measurement temperature.

FIG. 34A to FIG. 34C are STEM images illustrating a positive electrode active material after a cycling test.

FIG. 35A to FIG. 35C are STEM images illustrating a positive electrode active material after a cycling test.

FIG. 36 is an image illustrating a positive electrode active material after a cycling test.

FIG. 37 is an image illustrating a positive electrode active material after a cycling test.

FIG. 38 is a graph showing electrode density.

### MODE FOR CARRYING OUT THE INVENTION

Examples of embodiments of the present invention will be described in detail below with reference to the drawings and the like. Note that the present invention should not be interpreted as being limited to the examples of embodiments given below. Embodiments of the invention can be changed unless it deviates from the spirit of the present invention.

In this specification and the like, the Miller index is sometimes used for the expression of crystal planes and crystal orientations. An individual plane that shows a crystal plane is sometimes denoted by “( )”. In the crystallography, a bar is placed over a number in the expression of crystal planes, crystal orientations, and space groups: in this specification and the like, because of format limitations, crystal planes, crystal orientations, and space groups are sometimes expressed by placing a minus sign (−) in front of a number instead of placing a bar over the number.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ (also referred to as lithium cobalt oxide) is 274 mAh/g, the theoretical capacity of LiNiO₂ is 274 mAh/g, and the theoretical capacity of LiMn₂O₄ is 148 mAh/g.

In this specification and the like, a charge depth is a value indicating the degree of capacity that has been charged, i.e., the amount of lithium extracted from a positive electrode, relative to the theoretical capacity of a positive electrode active material as reference: the minimum charge depth is obtained when all the lithium that can be inserted and extracted is inserted, and the maximum charge depth is obtained when all the lithium that can be inserted and extracted is extracted.

### Embodiment 1

In this embodiment, a positive electrode active material having a defect is described.

A just-manufactured positive electrode active material sometimes has a defect. If not present in a positive electrode active material just after manufacture, a defect is sometimes generated therein by repetition of charging and discharging. “Repetition of charging and discharging” encompasses repetition of charging and discharging in a cycling test using a half cell or a full cell, and repetition of charging and discharging is referred to as charging and discharging in some cases.

The defect due to charging and discharging is generated presumably because a chemical or electrochemical reaction is caused between a material of the positive electrode active material and an electrolyte solution around the positive electrode active material. This reaction sometimes corrodes the positive electrode active material. When the positive electrode active material is degraded by charging and discharging, a defect is sometimes generated. In some cases, the defect after charging and discharging is generated locally, not uniformly, in the positive electrode active material. Moreover, the defect sometimes progresses. The present inventors considered that determining or controlling such a defect is important for improvement of battery characteristics obtained in a cycling test, i.e., cycling performance.

Generation or progression of a defect correlates with charging and discharging conditions such as cycling test conditions. For example, there is sometimes a difference in generation or progression of a defect, depending on whether the conditions are such that the charge depth is large (e.g., charging is performed at a voltage higher than or equal to 4.5 V) or the conditions are such that the charge depth is not large. For another example, there is sometimes a difference in generation or progression of a defect, depending on whether the conditions are such that the temperature is higher than or equal to 45° C. or the conditions are such that the temperature is not higher than or equal to 45° C. That is, a defect correlates with cycling test conditions.

Here, the kinds of defects are described. A defect that progresses owing to charging and discharging is sometimes referred to as a pit in this specification and the like. It is assumed that progression of a pit is accelerated by charging and discharging under conditions such as a high voltage or a high temperature. As a result, many pits are presumably generated in a positive electrode active material that has undergone charging and discharging under the above conditions.

A defect like a crevice due to expansion and contraction of a positive electrode active material by charging and discharging is sometimes referred to as a crack in this specification and the like. It is assumed that progression of a crack is accelerated by charging and discharging under conditions such as a high voltage or a high temperature. As a result, many cracks are presumably generated in a positive electrode active material that has undergone charging and discharging under the above conditions.

A positive electrode active material not only expands and contracts but also is subjected to local stress during charging and discharging in some cases. In the part subjected to the local stress, a defect such as a split is easily generated. The split cannot be observed on a surface of the positive electrode active material in some cases. That is, the split is inside the positive electrode active material. In some cases, the split is referred to as a closed split (a closed crack or a crack closure) and is distinguished from a split that is generated from a surface of a positive electrode active material in this specification and the like. It is assumed that charging and discharging under conditions such as a high voltage or a high temperature facilitate generation of a closed split and accelerate progression thereof. As a result, many closed splits are presumably generated in a positive electrode active material that has undergone charging and discharging under the above conditions.

The present inventors considered that such defects generated in a positive electrode active material lead to a reduction in cycling performance, e.g., a reduction in discharge capacity retention rate.

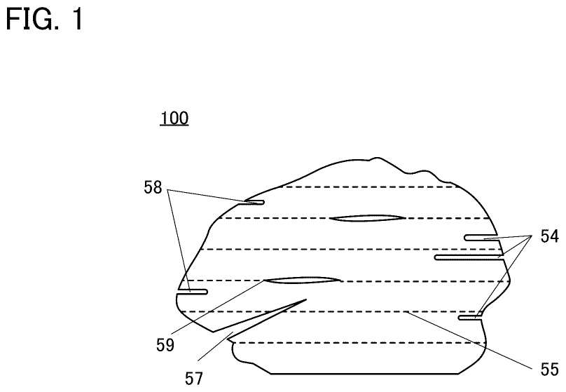

FIG. 1 is a schematic cross-sectional view of a positive electrode active material 100 in which defects are generated. The positive electrode active material 100 is assumed to have a layered rock-salt crystal structure, and a crystal plane 55 parallel to alignment of cations of the positive electrode active material 100 is also indicated by a dashed line in FIG. 1.

The positive electrode active material 100 includes pits 54 and pits 58 as defects. The pits 54 and the pits 58 are illustrated as holes extending in directions substantially parallel to the crystal plane 55, and the pits 54 and the pits 58 are three-dimensional and deep and have a groove-like shape. A source of a pit can be a point defect. A “pit” encompasses an aperture generated by a phenomenon sometimes called pitting corrosion, in which a point defect progresses to become a large hole.

The crystal structure of the positive electrode active material 100 breaks near the pits 54 and the pits 58 to become a crystal structure different from a layered rock-salt crystal structure, such as a spinel structure, in some cases. The breakage of the crystal structure might inhibit diffusion and release of lithium ions that are carrier ions: thus, the pits 54, the pits 58, and the like probably cause degradation of cycling performance.

The positive electrode active material 100 includes a crack 57 as a defect. The crack 57 is illustrated as cutting across the crystal plane 55. The crack 57 and the like probably cause degradation of cycling performance.

The crack 57 can be regarded as a defect of a different kind from the pits 54 and the pits 58. For example, the crack 57 progresses while cutting across the crystal plane 55, unlike the pits 54 and the pits 58 progressing substantially parallel to the crystal plane 55.

Furthermore, the crack 57 is sometimes present in a just-manufactured positive electrode active material, unlike the pits 54 and the pits 58 sometimes absent in a just-manufactured positive electrode active material. The pits 54 and the pits 58, which are absent in a just-manufactured positive electrode active material, can be regarded as apertures formed by extraction of some layers of cobalt and oxygen in a positive electrode active material due to a cycling test. The apertures can be regarded as regions from which cobalt has been eluted. Meanwhile, the crack 57 can be regarded as corresponding to a surface newly formed by application of physical pressure or a crevice generated owing to a crystal grain boundary, and is generated by pressing or the like in some cases.

The positive electrode active material 100 includes a closed split 59 as a defect. A closed split is generated inside a positive electrode active material in many cases: thus, a closed split is difficult to observe on a surface of the positive electrode active material and can be observed by cross-sectional observation of a positive electrode active material as shown in FIG. 1. The closed split 59 and the like probably cause degradation of cycling performance.

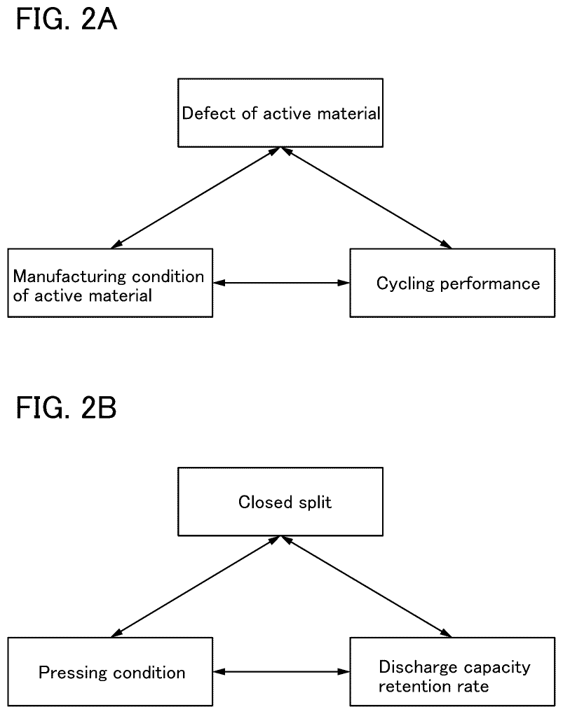

The present inventors intensively studied the above-described defects to find out that a defect of an active material correlates with the manufacturing conditions of the active material and that the defect, the manufacturing conditions, and cycling performance correlate with one another as shown in FIG. 2A.

The present inventors further studied the above correlation to find out that at least a closed split generated in an active material after a cycling test correlates with the pressing conditions of the active material and that the closed split, the pressing conditions, and a discharge capacity retention rate correlate with one another as shown in FIG. 2B.

To inhibit generation of a closed split, the pressing conditions of an active material among the manufacturing conditions thereof are preferably controlled. Generation of a closed split is inhibited when the pressing conditions are set such that the linear pressure is higher than or equal to 100 KN/m and lower than or equal to 3000 kN/m, preferably higher than or equal to 150 KN/m and lower than or equal to 1500 KN/m, further preferably higher than or equal to 210 KN/m and lower than or equal to 1467 kN/m. That is, the active material is preferably pressed under the above linear pressure to inhibit generation of a closed split.

An active material in which generation of a closed split is inhibited enables a high discharge capacity retention rate. In other words, generation of a closed split is inhibited in an active material that enables a high discharge capacity retention rate. An active material preferably includes 10 or less closed splits to enable a high discharge capacity retention rate. These findings concerning the correlations, which were made with a focus on a defect of a just manufactured active material and an active material after a cycling test, are very useful for improvement of cycling performance.

An active material pressed under a linear pressure higher than or equal to 100 KN/m and lower than or equal to 3000 KN/m, preferably higher than or equal to 150 KN/m and lower than or equal to 1500 KN/m, further preferably higher than or equal to 210 kN/m and lower than or equal to 1467 kN/m enables an electrode to have an electrode density higher than or equal to 2.5 g/cc and lower than or equal to 4.5 g/cc, preferably higher than or equal to 3.3 g/cc and lower than or equal to 4.1 g/cc, and a secondary battery preferably includes this active material to have an increased discharge capacity retention rate.

An active material pressed under a linear pressure higher than or equal to 100 KN/m and lower than or equal to 3000 KN/m, preferably higher than or equal to 150 KN/m and lower than or equal to 1500 KN/m, further preferably higher than or equal to 210 kN/m and lower than or equal to 1467 kN/m enables an electrode to have a porosity higher than or equal to 8% and lower than or equal to 35%, preferably higher than or equal to 12% and lower than or equal to 29%, and a secondary battery preferably includes this active material to have an increased discharge capacity retention rate.

This embodiment can be used in combination with any of the other embodiments.

### Embodiment 2

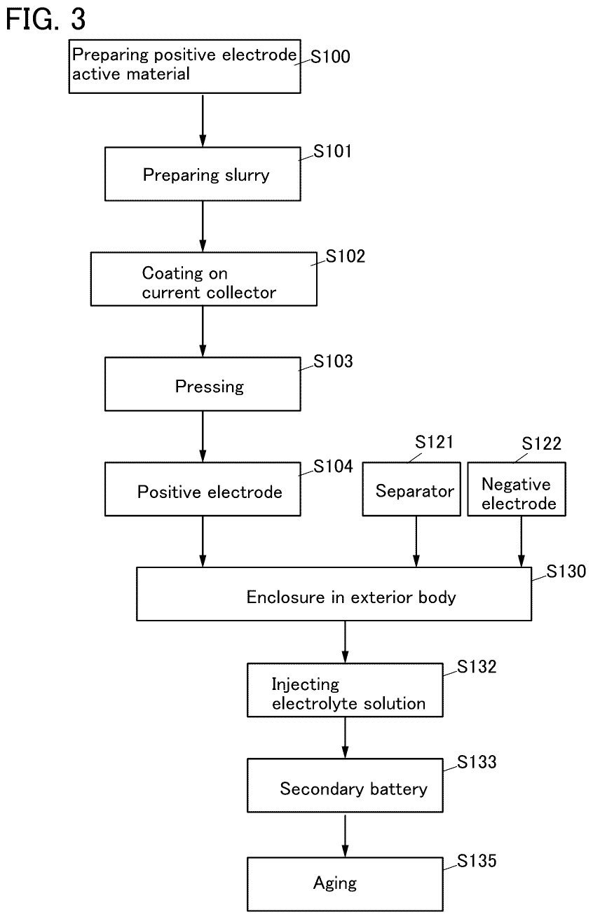

In this embodiment, a manufacturing method, a manufacturing apparatus, and the like of a secondary battery are described with reference to FIG. 3 and the like.

### <<Preparing Positive Electrode Active Material>>

In Step S100 shown in FIG. 3, a positive electrode active material is prepared. A manufacturing method and the like of the positive electrode active material will be described in detail in Embodiment 3 and the like. Here, a material and the like usable for the positive electrode active material are described.

### [Positive Electrode Active Material]

Examples of the positive electrode active material include a lithium-containing oxide and a lithium-containing composite oxide with an olivine crystal structure, a lithium-containing oxide and a lithium-containing composite oxide with a layered rock-salt crystal structure, and a lithium-containing oxide and a lithium-containing composite oxide with a spinel crystal structure. As the positive electrode active material of one embodiment of the present invention, a positive electrode active material with a layered rock-salt crystal structure is preferably used.

As the lithium-containing composite oxide with a layered rock-salt crystal structure, for example, it is possible to use a lithium-containing composite oxide represented by LiMₓO_{y} (x>0 and y>0, specifically y=2 and 0.8<x<1.2, for example). Here, the element M is a metal element, which is preferably one or two or more selected from cobalt, manganese, nickel, and iron. It is further preferable that the element M be a combination of one or more selected from cobalt, manganese, nickel, and iron and one or more selected from aluminum, titanium, zirconium, lanthanum, copper, and zinc, for example.

Examples of the lithium-containing composite oxide represented by LiMₓO_{y} include LiCoO₂ (also referred to as lithium cobalt oxide), LiNiO₂, and LiMnO₂. In addition, examples of a lithium-containing composite oxide represented by LiNiₓCo₁₋ₓO₂ (0<x<1) include a NiCo-based material, and examples of the lithium-containing composite oxide represented by LiMₓO_{y} include a NiMn-based material represented by LiNiₓMn₁₋ₓO₂ (0<x<1).

Examples of a lithium-containing composite oxide represented by LiMO₂ include a NiCoMn-based material (also referred to as NCM-based material or lithium nickel-cobalt-manganese oxide) represented by LiNiₓCo_{y}Mn_{z}O₂ (x>0, y>0, and 0.8<x+y+z<1.2). Specifically. 0.1x<y<8x and 0.1x<z<8x are preferably satisfied in the above. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

Examples of the lithium-containing composite oxide with a layered rock-salt crystal structure include Li₂MnO₃ and Li₂MnO₃—LiMeO₂ (Me represents Co, Ni, or Mn).

With the use of a positive electrode active material with a layered rock-salt crystal structure typified by the above-described lithium-containing composite oxide, a secondary battery with a large amount of lithium per volume and a high capacity per volume can be provided.

Examples of the positive electrode active material include manganese-containing LiMn₂O₄ with a spinel crystal structure. The above LiMn₂O₄ and lithium nickel oxide (represented by LiNiO₂ or LiNi₁₋ₓMₓO₂ (0<x<1) (M=Co, Al, or the like) may be mixed to be used for the positive electrode active material. Such a composition in which different composite oxides are mixed can improve the characteristics of a secondary battery.

As the positive electrode active material, a lithium-manganese composite oxide that can be represented by LiₐMn_{b}M_{c}O_{d} can be used. Here, the element M is preferably silicon, phosphorus, or one or two or more metal elements other than lithium and manganese, and it is further preferable that the metal elements include nickel. Furthermore, it is preferable that in the above LiₐMn_{b}M_{c}O_{d}, the following be satisfied at the time of discharging: 0<a/(b+c)<2; c>0; and 0.26≤(b+c)/d<0.5. Note that a “lithium-manganese composite oxide” means an oxide containing at least lithium and manganese and encompasses the above LiMn₂O₄. The lithium-manganese composite oxide may contain, in addition to the elements included in its chemical formula, one or two or more elements selected from chromium, cobalt, aluminum, nickel, iron, magnesium, molybdenum, zinc, indium, gallium, copper, titanium, niobium, silicon, phosphorus, and the like.

As the positive electrode active material, lithium-ion-free V₂O₅ or Cr₃O₈ may be used, for example.

The proportion of a metal element, silicon, phosphorus, or the like in the whole lithium-containing composite oxide can be measured with, for example, an ICP-MS (inductively coupled plasma mass spectrometer). The proportion of oxygen in the whole lithium-containing composite oxide can be measured by, for example, EDX (energy dispersive X-ray spectroscopy). Alternatively, the proportion of oxygen can be measured by ICPMS combined with fusion gas analysis and valence evaluation of XAFS (X-ray absorption fine structure) analysis.

As the positive electrode active material, a combination of two or more of the above materials may be used.

### <<Preparing Slurry>>

Next, in Step S101 shown in FIG. 3, a slurry containing the positive electrode active material is prepared.

### [Slurry]

A slurry is formed by mixing at least an active material in a solvent. A slurry in which a positive electrode active material is mixed is referred to as a positive electrode slurry and a slurry in which a negative electrode active material is mixed is referred to as a negative electrode slurry in some cases. In a slurry, a conductive additive and a binding agent (also referred to as a binder) may be mixed in addition to the active material.

The proportion of the positive electrode active material or negative electrode active material in the slurry is preferably higher than or equal to 85 wt % and lower than or equal to 98 wt %, further preferably higher than or equal to 90 wt % and lower than or equal to 98 wt %.

Particles of the active material and the like sometimes aggregate in the slurry; thus, to increase the dispersibility of the particles, the affinity between the solvent and the particles of the active material and the like is preferably increased. Accordingly, not only the active material and the like but also a dispersant may be mixed in the slurry.

### [Solvent]

As the solvent, one or two or more selected from a ketone such as acetone, an alcohol such as ethanol or isopropanol, an ether, dioxane, acetonitrile, N-methyl-2-pyrrolidone (NMP), and the like can be used. An aprotic solvent, which is unlikely to react with lithium, is preferably used.

Two or more of the above materials may be used in combination for the solvent.

### [Conductive Additive]

A conductive additive is also referred to as a conductivity-imparting agent or a conductive material, and a carbon material is often used as the conductive additive. The conductive additive is sometimes positioned between a plurality of active materials or between an active material and a current collector.

Examples of the carbon material of the conductive additive include carbon black. Examples of carbon black include furnace black, acetylene black, and graphite.

Graphene or a graphene compound may be used as the carbon material of the conductive additive. Graphene (also referred to as G in some cases) contains carbon and has a two-dimensional structure that includes a six-membered ring composed of the carbon. The two-dimensional structure formed of the six-membered ring composed of the carbon is in the form of a sheet and may accordingly be referred to as a carbon sheet.

A graphene compound contains graphene oxide (also referred to as GO in some cases) or reduced graphene oxide (also referred to as RGO in some cases). In graphene oxide, a functional group is bonded to graphene and the functional group contains oxygen. Reduced graphene oxide is graphene oxide after reduction that is obtained through reduction of graphene oxide, and in some cases, does not contain oxygen depending on the degree of reduction. Such a graphene compound also has a two-dimensional structure formed of six-membered rings composed of carbon. A graphene compound is in the form of a sheet or a net. A graphene compound in the form of a net is sometimes referred to as a graphene net. A graphene net can cover an active material partly or entirely: furthermore, a graphene net covering an active material can include a region along the active material, so as to form an efficient conductive path. A graphene net can also function as a binding agent for binding active materials. This allows using a smaller amount of or no binding agent, which can increase the proportion of the active material in the electrode volume and the electrode weight.

As the carbon material of the conductive additive, multilayer graphene may be used. “Multilayer graphene” encompasses a material in which 2 to 300 layers of graphene, preferably 80 to 200 layers of graphene, are stacked, and sometimes has a bent shape.

Graphene or a graphene compound preferably has a hole for passage of carrier ions. A “hole” encompasses a defect in graphene or a graphene compound. By bonding of a plurality of graphenes or a plurality of graphene compounds, net-shaped graphene or a net-shaped graphene compound can be formed. Net-shaped graphene or a net-shaped graphene compound can have a hole.

As the carbon material of the conductive additive, a carbon material with which a surface of the active material can be covered in advance using a spray dry apparatus may be used. The active materials whose surfaces are covered with the carbon material in advance can form an efficient conductive path.

As the carbon material of the conductive additive, a needle-shaped material such as carbon nanotube (sometimes referred to as CNT) or VGCF (registered trademark) may be used.

Two or more of the above materials may be used in combination for the conductive additive.

### [Binding Agent]

As the binding agent, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binding agent.

As the binding agent, for example, a water-soluble polymer is preferably used. As the water-soluble polymer, a polysaccharide can be used, for example. As the polysaccharide, one or more selected from starch, a cellulose derivative such as carboxymethyl cellulose (CMC), methyl cellulose, ethyl cellulose, hydroxypropyl cellulose, diacetyl cellulose, or regenerated cellulose, and the like can be used. It is further preferable that such a water-soluble polymer be used in combination with any of the above rubber materials.

As the binding agent, one or more selected from polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, nitrocellulose, and the like is preferably used.

Two or more of the above materials may be used in combination for the binding agent.

### <<Coating on Current Collector>>

Next, in Step S102 shown in FIG. 3, a current collector for a positive electrode (sometimes referred to as a positive electrode current collector) is coated with the positive electrode slurry. Coating on one surface of a positive electrode current collector is referred to as single-side coating, and coating on both sides of a positive electrode current collector is referred to as double-side coating in some cases.

### [Positive Electrode Current Collector]

The positive electrode current collector can be formed using a high-conductivity material that is a metal such as stainless steel, gold, platinum, aluminum, or titanium, an alloy thereof, or the like. The positive electrode current collector is preferably formed using a material that will not be eluted at the potential of the positive electrode of the secondary battery. The positive electrode current collector can also be formed using an aluminum alloy to which an element that improves heat resistance, such as silicon, titanium, neodymium, scandium, or molybdenum, is added. The positive electrode current collector may contain a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel.

The positive electrode current collector can have a foil-like shape, a plate-like shape, a sheet-like shape, a net-like shape, a punching-metal shape, an expanded-metal shape, or the like as appropriate.

The thickness of the positive electrode current collector is preferably greater than or equal to 5 μm and less than or equal to 30 μm, further preferably greater than or equal to 10 μm and less than or equal to 20 μm.

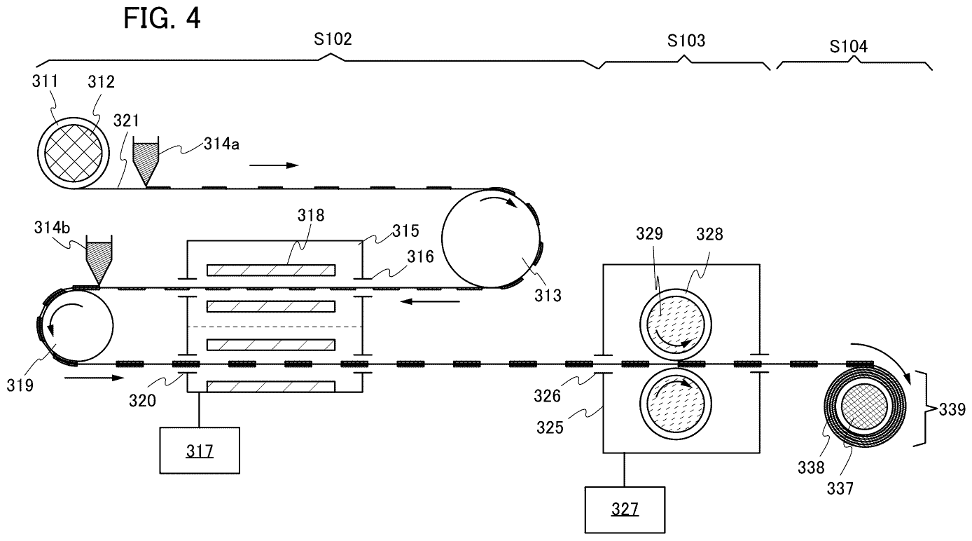

Here, examples of a manufacturing apparatus for coating the positive electrode current collector with the positive electrode slurry and the like are described with reference to FIG. 4. FIG. 4 shows the case where a roll-to-roll method is used in Step S102.

FIG. 4 shows a delivering mechanism 312 (sometimes referred to as an unwinder) for Step S102 shown in FIG. 3. The delivering mechanism 312 is provided with a first bobbin 311 around which a sheet-shaped positive electrode current collector 321 is wound. The positive electrode current collector 321 can be transferred in the arrow direction by rotation of a roller 313 and the like. One surface (corresponding to a front surface) of the positive electrode current collector 321 can be coated with the positive electrode slurry using a first slurry attaching means 314a. Examples of the slurry attaching means include a slot die coater, a lip coater, a blade coater, a reverse coater, and a gravure coater. The number of rollers may be increased to reverse the positive electrode current collector 321, depending on the type of the coater. The slurry attaching means can employ a dipping method, a spraying method, or the like.

FIG. 4 shows an example of the case where intermittent coating is employed for coating with the positive electrode slurry. Intermittent coating allows coating of selective regions with the positive electrode slurry, and the positive electrode current collector 321 would be exposed between a plurality of regions coated with the positive electrode slurry.

After the coating, the positive electrode slurry is dried by using a drying means 315. The drying means 315 is provided with a carry-in port 316. Note that the carry-in port 316 forms a pair with another carry-in port, which is sometimes referred to as a carry-out port.

Inside the drying means 315 is provided a heat source 318. The positive electrode current collector 321 that has been carried in through the carry-in port 316 is exposed to the heat source 318, so that the positive electrode slurry can be dried. At least the solvent is removed from the dried positive electrode slurry. The temperature for the drying, i.e., the temperature of the heat source 318, is preferably higher than or equal to 80° C. and lower than or equal to 180° C., further preferably higher than or equal to 100° C. and lower than or equal to 130° C. For the heat source 318, one method or a combination of two or more methods selected from hot-air heating, lamp heating, induction heating, air blowing, and the like can be employed. A plurality of the heat sources 318 may be provided so that the positive electrode current collector 321 can be held therebetween. The distance between the heat source 318 and the positive electrode current collector 321 is preferably greater than or equal to 5 cm and less than or equal to 30 cm, further preferably greater than or equal to 10 cm and less than or equal to 20 cm.

The drying means 315 is provided with a control portion 317, with which the above-described drying conditions can be controlled.

The drying means 315 may be provided with an outlet. The outlet is preferably provided in the upper portion, e.g., the ceiling, of the drying means 315.

In the case of single-side coating, the coating is completed when the positive electrode slurry on one surface of the positive electrode current collector 321 is dried. The positive electrode slurry which has been subjected to drying treatment and from which at least the solvent has been removed is referred to as a positive electrode mixture in some cases.

In the case of double-side coating, the other surface (corresponding to a rear surface, for example) of the positive electrode current collector 321 is coated with the slurry by a second slurry attaching means 314b after delivery from the drying means 315. A roller 319 is used to make the other surface of the positive electrode current collector 321 face the second slurry attaching means 314b. The positive electrode current collector 321 can be transferred in the arrow direction by rotation of the roller 319. The positive electrode mixture that has been provided on the one surface of the positive electrode current collector 321 by the previous coating may touch the roller 319 because the positive electrode mixture has been subjected to the drying treatment.

The positive electrode slurry provided by coating on the other surface of the positive electrode current collector 321 is dried by using the drying means 315. The drying means 315 is provided with a carry-in port 320. Note that the carry-in port 320 forms a pair with another carry-in port, which is sometimes referred to as a carry-out port. The positive electrode current collector 321 that has been carried in through the carry-in port 320 is exposed to the heat source 318, so that the positive electrode slurry can be dried. The aforementioned carry-in port 316 can serve as the carry-in port 320, in which case the carry-in port 320 can be omitted. Through the above-described process, coating on the current collector is completed.

### <<Pressing>>

Next, in Step S103 shown in FIG. 3, the positive electrode mixture and the positive electrode current collector 321 are subjected to pressing (also referred to as pressurization in some cases). Pressing can be performed by a roll press method, a flat plate press method, or the like. In this embodiment, the positive electrode mixture and the positive electrode current collector 321 are pressed by a roll press method, for example.

Here, a pressurization means 325 that can be used for a roll press method is described with reference to FIG. 4. A pressurization means is sometimes referred to as a roll press device.

The pressurization means 325 is provided with a carry-in port 326. Note that the carry-in port 326 forms a pair with another carry-in port, which is sometimes referred to as a carry-out port. Inside the pressurization means 325 are provided a pair of rollers 328. An object can be pressed by passing between the pair of rollers 328. For the pressurization means 325, a pair of rollers with a load greater than or equal to 100 kg and less than or equal to 200 t, a roll width greater than or equal to 100 mm and less than or equal to 3000 mm, and a roll diameter ($) greater than or equal to 30 mm and less than or equal to 5000 mm can be used. The pressurization means 325 can employ an air cylinder or hydraulic pressure as a pressurization method, and manual pressurization can be performed with the pressurization means 325.

The pair of rollers 328 each preferably include a heat source 329 to perform pressing and heating concurrently. For example, the positive electrode current collector 321 that has been carried in through the carry-in port 326 is pressed while being exposed to the heat source 329. The heat sources 329 are not necessarily provided inside the pair of rollers 328. For the heat source 329, which can generate heat by steam heating or electric heating, one or a combination of two or more selected from hot-air heating, lamp heating, induction heating, air blowing, and the like can be specifically used. In addition to the heat source, a cooling source may be provided; for example, cooling water is preferably used as the cooling source. Needless to say, the pressurization means 325 can perform pressing at room temperature.

The pressurization means 325 may be provided with an outlet. The outlet is preferably provided in the upper portion, e.g., the ceiling, of the pressurization means 325.

The pressure at the time of pressing (sometimes referred to as pressing pressure) is preferably a linear pressure higher than or equal to 100 KN/m and lower than or equal to 3000 KN/m, further preferably higher than or equal to 150 kN/m and lower than or equal to 1500 KN/m, still further preferably higher than or equal to 210 kN/m and lower than or equal to 1467 kN/m. With a width of 4 cm, a linear pressure of 210 kN/m corresponds to a contact pressure of 1 MPa, a linear pressure of 461 kN/m corresponds to a contact pressure of 2 MPa, a linear pressure of 964 KN/m corresponds to a contact pressure of 4 MPa, and a linear pressure of 1467 kN/m corresponds to a contact pressure of 6 MPa. The pressing pressure is preferably a contact pressure higher than or equal to 1 MPa and lower than or equal to 6 MPa. Pressing under the above linear pressure can inhibit a defect that might be generated in the positive electrode active material, i.e., a possible cause of cycling performance degradation.

The number of times of pressing can be one or two or more. In the case where pressing is performed twice or more, the pressure of the first pressing is preferably lower than that of the final pressing. In the case where pressing is performed twice or more, it is preferable that a second pair of rollers be provided inside the pressurization means 325 and the first pressing and the final pressing be performed continuously.

The heating temperature at the time of pressing, i.e., the temperature of the heat source 329, is preferably higher than or equal to 90° C. and lower than or equal to 180° C., further preferably higher than or equal to 90° C. and lower than or equal to 120° C. Heating allows softening of at least the binding agent (e.g., PVDF) contained in the positive electrode mixture, so as to increase the electrode density in the positive electrode.

Pressing is preferably performed under the above-described linear pressure, in which case the electrode density of the positive electrode is higher than or equal to 2.5 g/cc and lower than or equal to 4.5 g/cc, preferably higher than or equal to 3.3 g/cc and lower than or equal to 4.1 g/cc, a defect of the positive electrode is inhibited, and the electrode density of the positive electrode can be high.

Pressing is preferably performed under the above-described linear pressure, in which case the porosity of the positive electrode is higher than or equal to 8% and lower than or equal to 35%, preferably higher than or equal to 12% and lower than or equal to 29%, a defect of the positive electrode is inhibited, and the electrode density of the positive electrode can be high.

Note that the porosity of the positive electrode is the proportion of the region that is not filled with the positive electrode active material, the conductive additive, or the binding agent. In a completed secondary battery, an electrolyte solution is sometimes in this region that is not filled with the positive electrode active material, the conductive additive, or the binding agent, but the porosity of the positive electrode is a value not affected by the electrolyte solution. The porosity of the positive electrode can be calculated from the filling rate of the positive electrode.

The porosity can be determined through cross-sectional observation of the electrode. For example, the porosity of a sample whose cross section has been processed by a focused ion beam (FIB) can be observed by an observation apparatus such as a SEM (Scanning Electron Microscope) or a TEM (Transmission Electron Microscope). An FIB enables continuous processing of a sample and continuous observation, which in turn allows three-dimensional observation of porosity. Continuously performing processing and observation is referred to as Slice & View in some cases.

The pressurization means 325 is provided with a control portion 327, with which pressing conditions can be controlled. The pressing conditions include the rotational speed of the rollers, as well as the pressure and temperature.

### <<Preparing Positive Electrode>>

In Step S104 shown in FIG. 3, the positive electrode obtained as described above is prepared.

For example, in the manufacturing apparatus shown in FIG. 4, a rolled positive electrode 339 that is wound around a second bobbin 338 provided in a winding-up mechanism 337 (sometimes referred to as a winder) can be obtained for Step S104.

The rolled positive electrode 339 can be used as a positive electrode of a wound secondary battery. In the case where the rolled positive electrode 339 is used as a positive electrode of a wound secondary battery, the length of the long side of the positive electrode is preferably greater than or equal to 30 cm and less than or equal to 100 cm, and the rolled positive electrode 339 is preferably cut to have this length of the long side. The length of the long side corresponds to the length in the direction along the direction in which the sheet-shaped positive electrode current collector 321 is moved.

The rolled positive electrode 339 can be used as a positive electrode of a stacked secondary battery. In the case where the rolled positive electrode 339 is used as a positive electrode of a stacked secondary battery, the length of the long side of the positive electrode is preferably greater than or equal to 5 cm and less than or equal to 20 cm, and the rolled positive electrode 339 is preferably cut to have this length of the long side. Cutting may be performed before the rolled positive electrode 339 is formed. The length of the long side corresponds to the length in the direction intersecting with the direction in which the sheet-shaped positive electrode current collector 321 is moved.

### <<Preparing Separator>>

In Step S121 shown in FIG. 3, a separator is prepared.

### [Separator]

The separator can be formed using, for example, paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably formed to have an envelope-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide and silicon oxide. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved: hence, degradation of the separator during high-voltage charging and discharging can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

The use of a separator having a multilayer structure makes it possible to maintain the safety of the secondary battery even when the total thickness of the separator is small, so that the discharge capacity per volume of the secondary battery can be increased.

### <<Preparing Negative Electrode>>

In Step S122 shown in FIG. 3, a negative electrode is prepared. The negative electrode can be formed as a rolled negative electrode like the positive electrode by the manufacturing apparatus and the like shown in FIG. 4 and the like.

### [Negative Electrode]

The negative electrode includes a negative electrode active material layer and a negative electrode current collector. The negative electrode active material layer is sometimes referred to as a negative electrode mixture and may include a conductive additive and a binding agent. A material and the like usable for the negative electrode active material are described.

### [Negative Electrode Active Material]

For the negative electrode active material, an element that enables charge and discharge reactions by an alloying reaction and a dealloying reaction with lithium can be used. For example, an element containing one or two or more selected from silicon, tin, gallium, aluminum, germanium, lead, antimony, bismuth, silver, zinc, cadmium, indium, and the like can be used. Such elements have a higher capacity than carbon. In particular, silicon has a high theoretical capacity of 4200 mAh/g. For this reason, silicon is preferably used as the negative electrode active material. Alternatively, a compound containing any of the above elements may be used.

Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charging and discharging reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, it is preferable that x be 1 or have an approximate value of 1. For example, x is preferably more than or equal to 0.2 and less than or equal to 1.5, further preferably more than or equal to 0.3 and less than or equal to 1.2.

Examples of the carbon material used in the negative electrode include graphite, graphitizing carbon (soft carbon), non-graphitizing carbon (hard carbon), a carbon nanotube, graphene, and carbon black.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a secondary battery that includes graphite can have a high operating voltage. In addition, graphite is preferable because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high capacity (900 mAh/g and 1890 mAh/cm³).

A composite nitride of lithium and a transition metal is preferably used, in which case lithium ions are contained in the negative electrode active material and thus the negative electrode active material can be used in combination with a material for the positive electrode active material that does not contain lithium ions, such as V₂O₅ or Cr₃O₈.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Lithium can also be used as the negative electrode active material. In the case of using lithium as the negative electrode active material, lithium foil can be provided over the negative electrode current collector. Lithium may also be provided over the negative electrode current collector by a gas phase method such as an evaporation method or a sputtering method. In a solution containing lithium ions, lithium may be deposited on the negative electrode current collector by an electrochemical method.

For the conductive agent and the binder that can be included in the negative electrode active material layer, materials similar to those for the conductive agent and the binder that can be included in the positive electrode active material layer can be used.

For the current collector, copper or the like can be used in addition to a material similar to that for the positive electrode current collector. Note that a material that is not alloyed with carrier ions of lithium or the like is preferably used for the negative electrode current collector.

As another form of the negative electrode, a negative electrode that does not include a negative electrode active material can be used. In a secondary battery fabricated using the negative electrode that does not include a negative electrode active material, lithium can be deposited on a negative electrode current collector at the time of charging, and lithium on the negative electrode current collector can be eluted at the time of discharging. Thus, lithium is on the negative electrode current collector in the states except for the completely discharged state.

In the case where the negative electrode that does not include a negative electrode active material is used, a film for making lithium deposition uniform may be provided over the negative electrode current collector. For the film for making lithium deposition uniform, for example, a solid electrolyte having lithium ion conductivity can be used. As the solid electrolyte, one or two or more selected from a sulfide-based solid electrolyte, an oxide-based solid electrolyte, a polymer-based solid electrolyte, and the like can be used. In particular, the polymer-based solid electrolyte can be uniformly formed as a film over the negative electrode current collector relatively easily, and thus is suitable for the film for making lithium deposition uniform.

In the case where the negative electrode that does not include a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that deposition of lithium having a dendrite-like shape can be inhibited.

### <<Enclosure in Exterior Body>>

Next, in Step S130 shown in FIG. 3, the positive electrode, the negative electrode, and the separator are enclosed in an exterior body. The exterior body is sealed after the enclosure preferably in a closed atmosphere where the outside air is blocked, e.g., in a glove box.

### [Exterior Body]

For the exterior body, one or two or more selected from metal materials such as aluminum and resin materials can be used, for example. The exterior body can have a structure in which a metal film containing one or two or more selected from aluminum, stainless steel, copper, nickel, and the like is provided over an organic film containing one or two or more selected from polyethylene, polypropylene, polycarbonate, an ionomer, polyamide, and the like. Furthermore, outside the metal film, an insulating synthetic resin film of a polyamide-based resin, a polyester-based resin, or the like can be provided as the outer surface of the exterior body to form a three-layer structure.

### <<Injecting Electrolyte Solution>>

Next, in Step S132 shown in FIG. 3, an electrolyte solution is injected in the exterior body

### [Electrolyte Solution]

The electrolyte solution contains a solvent and an electrolyte. As the solvent of the electrolyte solution, an aprotic organic solvent is preferably used. For example, one or a combination of two or more selected from ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used. When two or more kinds of solvents are combined, they can be used in an appropriate ratio.

Use of one or two or more kinds of ionic liquids (room temperature molten salts) that are unlikely to burn and volatize as the solvent of the electrolyte solution can prevent the secondary battery from exploding or catching fire, for example. An ionic liquid contains a cation and an anion. Examples of the cation used for the electrolyte solution include an organic cation; as examples of the organic cation, aliphatic onium cations such as a quaternary ammonium cation, a tertiary sulfonium cation, and a quaternary phosphonium cation, aromatic cations such as an imidazolium cation and a pyridinium cation, and the like can be given. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one lithium salt or a combination of two or more lithium salts selected from LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(FSO₂)₂, LiN(CF₃SO₂)₂, LiN(C₄F₉SO₂)(CF₃SO₂), LiN(C₂F₅SO₂)₂, and the like can be used. When two or more kinds of lithium salts are combined, they can be used in an appropriate ratio.

The electrolyte solution used for the secondary battery is preferably highly purified and contains small contents of dust particles or elements other than the constituent elements of the electrolyte solution (hereinafter, also simply referred to as “impurities”). Specifically, the weight ratio of impurities to the electrolyte solution is preferably lower than or equal to 1%, further preferably lower than or equal to 0.1%, still further preferably lower than or equal to 0.01%.

Furthermore, an additive agent such as vinylene carbonate, propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of the additive agent in the whole solvent is, for example, higher than or equal to 0.1 wt % and lower than or equal to 5 wt %. VC or LiBOB is particularly preferable because it facilitates formation of a favorable coating film.

A polymer gel electrolyte in which a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO): PVDF: polyacrylonitrile; and a copolymer containing any of them. For example, PVDF-HFP, which is a copolymer of PVDF and hexafluoropropylene (HFP), can be used. The formed polymer may be porous.

Instead of the electrolyte solution, a solid electrolyte including an inorganic material such as a sulfide-based or oxide-based inorganic material, a solid electrolyte including a polymer material such as a PEO (polyethylene oxide)-based polymer material, or the like can be used. When the solid electrolyte is used, a separator is not necessary. Furthermore, the secondary battery can be entirely solidified: therefore, there is no possibility of liquid leakage and thus the safety of the secondary battery is dramatically improved.

### <<Secondary Battery>>

In Step S133 shown in FIG. 3, the secondary battery can be obtained by following the above-described process and the like.

### <Wound Secondary Battery>

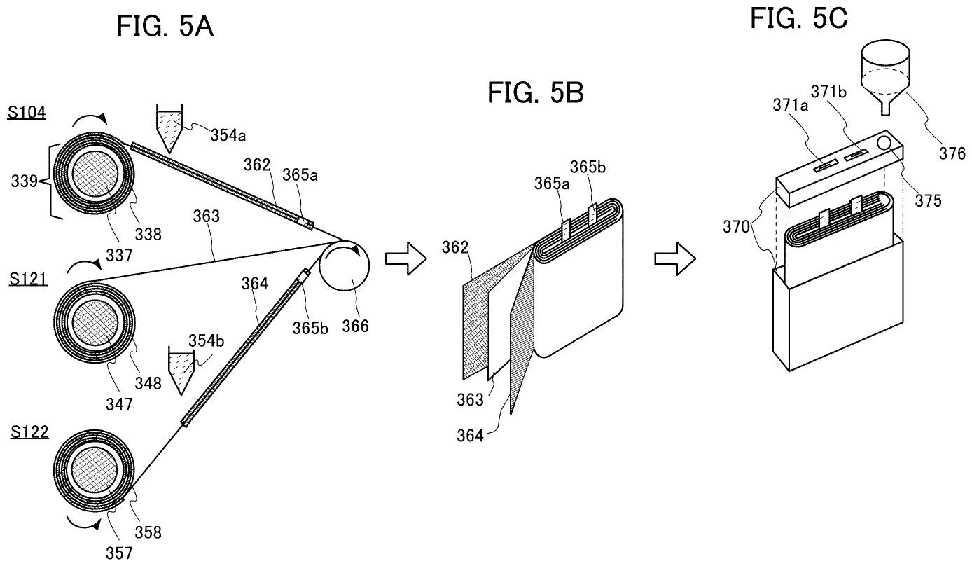

FIG. 5 shows an example of a manufacturing process of a wound secondary battery, which includes Step S104, Step S121, Step S122, Step S130, Step S132, Step S133, and the like.

As shown in FIG. 5A, the rolled positive electrode 339 described with reference to FIG. 4 can be used as a positive electrode prepared in Step S104. It is preferable to prepare the rolled positive electrode that is wound around the second bobbin 338 provided in the winding-up mechanism 337. The winding-up mechanism 337, which has a function of delivering a positive electrode to a roller 366, is referred to as a delivering mechanism in some cases.

As the separator prepared in Step S121, a rolled separator that is wound around a bobbin 348 provided in a winding-up mechanism 347 can be used. The winding-up mechanism 347, which has a function of delivering a separator to the roller 366, is referred to as a delivering mechanism in some cases.

As the negative electrode prepared in Step S122, a rolled negative electrode that is wound around a bobbin 358 provided in a winding-up mechanism 357 can be used. The winding-up mechanism 357, which has a function of delivering a negative electrode to the roller 366, is referred to as a delivering mechanism in some cases.

A sheet-shaped positive electrode 362, a sheet-shaped separator 363, and a sheet-shaped negative electrode 364 are delivered from the winding-up mechanisms by rotation of the roller 366 and the like and are superposed on one another at the roller 366 and in the vicinity thereof.

The directions of rotation of the winding-up mechanism 337 and the winding-up mechanism 347 are preferably opposite to the direction of rotation of the winding-up mechanism 357. When the direction of rotation of the winding-up mechanism around which at least the member to be the lowermost layer at the roller 366 is opposite to the directions of rotation of the other winding-up mechanisms, favorable superposition can be performed at the roller 366.

To the sheet-shaped positive electrode 362 that has been carried out from the winding-up mechanism 337, a tab 365a is preferably bonded by an attaching means 354a. The tab 365a is preferably superposed first at the roller 366 so as to be positioned at the central portion of the wound secondary battery.

To the sheet-shaped negative electrode 364 that has been carried out from the winding-up mechanism 357, a tab 365b is preferably bonded by an attaching means 354b. The tab 365b is preferably positioned on the winding center side of the wound secondary battery and is preferably superposed first at the roller 366.

As shown in FIG. 5B, the wound secondary battery can be assembled in which the sheet-shaped separator 363 is positioned between the sheet-shaped positive electrode 362 and the sheet-shaped negative electrode 364. In FIG. 5B, the tab 365a and the tab 365b are positioned at the central portion of the wound secondary battery.

FIG. 5C shows a state where the positive electrode 362, the separator 363, and the negative electrode 364 that are assembled in FIG. 5B are enclosed in an exterior body 370. It is preferable that the exterior body 370 include a slit 371a and a slit 371b for the tabs and include an opening 375 through which an electrolyte solution is to be injected.

With the use of an injecting means 376 for the electrolyte solution, the electrolyte solution can be injected through the opening 375.

Through the above-described process, the wound secondary battery can be obtained.

### <Stacked Secondary Battery>

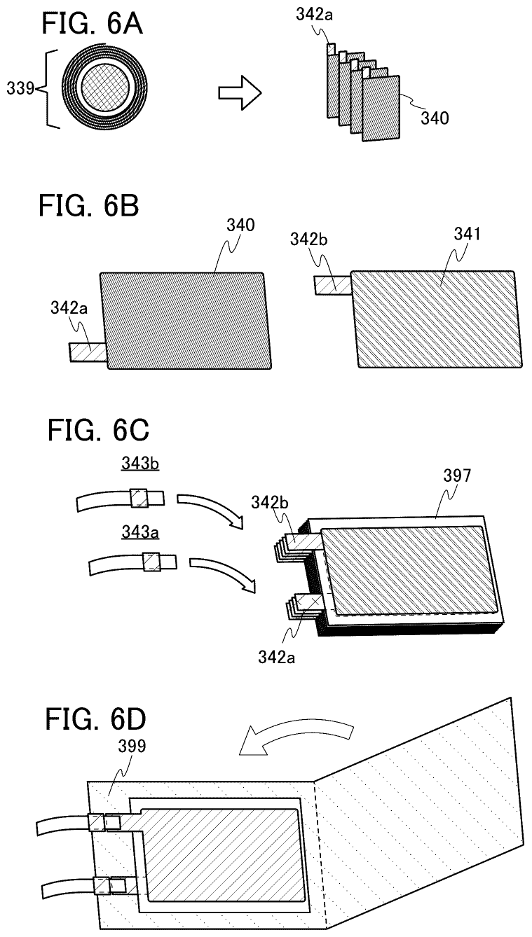

FIG. 6 shows an exemplary manufacturing process of a stacked secondary battery as an example of a secondary battery, which includes Step S104, Step S121, Step S122, Step S130, Step S132, Step S133, and the like.

As shown in FIG. 6A, the rolled positive electrode 339 and the like shown in FIG. 4 are cut into a predetermined size, so that a plurality of positive electrodes 340 are obtained. The rolled positive electrode 339 and the like can be cut such that the plurality of positive electrodes 340 each have a region for a tab 342a.

As shown in FIG. 6B, a plurality of negative electrodes 341 are prepared in a manner similar to that of the positive electrodes. The negative electrodes 341 can also be obtained by cutting a rolled negative electrode into a predetermined size. The rolled negative electrode can be cut such that the negative electrodes 341 each have a tab 342b.

As shown in FIG. 6C, separators 397 each of which is to be positioned between the positive electrode and the negative electrode are prepared and these are stacked. At this time, the positive electrodes 340 are stacked such that the positions of the tabs 342a are aligned. In a similar manner, the negative electrodes 341 are stacked such that the positions of the tabs 342b are aligned. It is preferable that an electrode 343a be bonded to the stacked tabs 342a and an electrode 343b be bonded to the stacked tabs 342b.

As shown in FIG. 6D, the positive electrodes 340, the separators 397, and the negative electrodes 341 that are stacked are enclosed in an exterior body 399, and the periphery of the exterior body 399 is sealed. At least one side of the exterior body 399 is preferably sealed after injection of the electrolyte solution.

Through the above-described process, the stacked secondary battery can be obtained.

### <<Aging>>

Next, in Step S135 shown in FIG. 3, aging is performed on the secondary battery. For the aging, the secondary battery is stored in a thermostatic oven at higher than or equal to 40° C. and lower than or equal to 60° C. for at least one day. This step is referred to as first aging treatment in some cases.

Furthermore, a cycling test may be conducted in which the upper voltage limit is set to a voltage (e.g., 4.3 V) in the range in which the SOC (State Of Charge) of the secondary battery is greater than or equal to 50% and less than or equal to 100% and the lower voltage limit is set to a voltage (e.g., 2.5 V) in the range in which the SOC is greater than or equal to 0% and less than or equal to 20%. The cycling test is conducted one to five times, preferably three or four times. This step is referred to as second aging treatment in some cases.

As aging treatment, only the first aging treatment is performed, only the second aging treatment is performed, or the first aging treatment and the second aging treatment are performed in this order.

By the first aging treatment or the second aging treatment, a coating film can be appropriately formed on the negative electrode. Part of the exterior body is preferably provided with an opening portion so that an unwanted gas and the like generated by the first aging treatment or the second aging treatment can be eliminated.

Through the above-described process, the secondary battery of one embodiment of the present invention can be manufactured. Defects can be inhibited in the secondary battery of one embodiment of the present invention, which can improve the cycling performance thereof.

This embodiment can be used in combination with any of the other embodiments.

### Embodiment 3

In this embodiment, a method for manufacturing a positive electrode active material of one embodiment of the present invention is described.

### <<Manufacturing Method 1 of Positive Electrode Active Material>

### <Step S11>

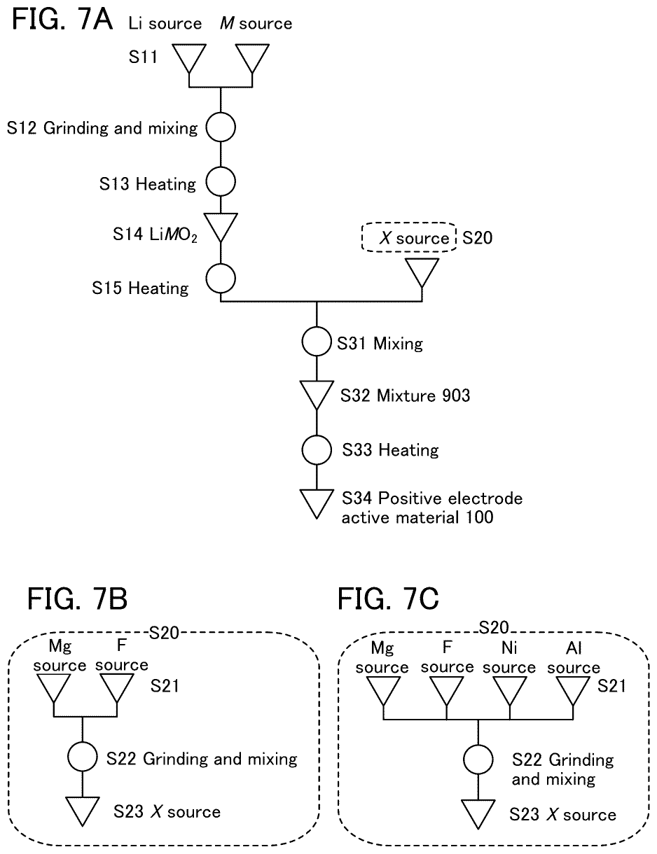

In Step S11 illustrated in FIG. 7A, a lithium source (referred to as a Li source in the drawing) and a transition metal source (referred to as an M source in the drawing) are prepared. A lithium source (Li source) and a transition metal source (M source) are referred to as starting materials in some cases.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal can be selected from the elements belonging to Groups 3 to 11 of the periodic table and for example, one or two or more of manganese, cobalt, and nickel is used. As the transition metal, for example, cobalt alone; nickel alone; two metals of cobalt and manganese; two metals of cobalt and nickel: or three metals of cobalt, manganese, and nickel may be used. When cobalt alone is used, the positive electrode active material to be obtained contains lithium cobalt oxide (LCO): when three metals of cobalt, manganese, and nickel are used, the positive electrode active material to be obtained contains lithium nickel cobalt manganese oxide (NCM).

In the case of using two or more transition metal sources, the two or more transition metal sources are preferably prepared to have proportions (mixing ratio) such that a layered rock-salt crystal structure would be obtained.

As the transition metal source, a compound containing the above transition metal is preferably used and for example, an oxide, a hydroxide, or the like of any of the metals given as examples of the transition metal can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used, although aluminum is not a transition metal.

The transition metal source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity or increased reliability can be obtained.

Furthermore, the transition metal source preferably has high crystallinity and for example, the transition metal source preferably includes single crystal grains. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

### <Step S12>

Next, in Step S12 shown in FIG. 7A, the lithium source and the transition metal source are ground and mixed to manufacture a mixed material (sometimes referred to as a mixture). The grinding and mixing can be performed by a dry method or a wet method. A wet method is preferable because it can crush a material into a smaller size. When the grinding and mixing are performed by a wet method, a solvent is prepared. As the solvent, a ketone such as acetone, an alcohol such as ethanol or isopropanol, an ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used as the solvent. It is preferable that the lithium source and the transition metal source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used for the mixing and the like. When a ball mill is used, alumina balls or zirconia balls are preferably used as a grinding medium. Zirconia balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the mixing is performed at a peripheral speed of 838 mm/s (the number of rotations: 400 rpm, the ball mill diameter: 40 mm).

### <Step S13>

Next, in Step S13 shown in FIG. 7A, the above mixed material is heated. The heating temperature is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the transition metal source. An excessively high temperature might lead to generation of a defect in the mixed material due to evaporation or sublimation of lithium from the lithium source and/or excessive reduction of the metal used as the transition metal source, for example. The defect is, for example, an oxygen defect in the mixed material which could be induced by a change of trivalent cobalt into divalent cobalt due to excessive reduction, in the case where cobalt is used as the transition metal.

The heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as dry air and, for example, the dew point of the atmosphere is preferably lower than or equal to −50° C., further preferably lower than or equal to −80° C. In this embodiment, the heating is performed in an atmosphere with a dew point of −93° C. To reduce impurities that might enter the mixed material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber, for example. The flow rate of a dry air in this case is preferably 10 L/min. Continuously introducing oxygen into a reaction chamber to make oxygen flow therein is referred to as “O₂ flowing”.

In the case where the heating atmosphere is an oxygen-containing atmosphere, flowing is not necessarily performed. For example, the following method may be employed: the pressure in the reaction chamber is reduced, the reaction chamber is then filled with oxygen, and the oxygen is prevented from entering or exiting from the reaction chamber. Such a method is sometimes referred to as “O₂ purging”. For example, the reaction chamber in which the pressure has been reduced to −970 hPa is filled with oxygen until the pressure reaches 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably an aluminum oxide (referred to as alumina) crucible. An alumina crucible has a material property that hardly releases impurities. In this embodiment, a crucible made of alumina with a purity of 99.9% is used. The heating is preferably performed with the crucible covered with a lid, in which case volatilization or sublimation of a material can be prevented.

The heated material is ground or crushed as needed and may be made to pass through a sieve. Before collection of the heated material, the material may be moved from the crucible to a mortar. As the mortar, an alumina mortar can be suitably used. An alumina mortar has a material property that hardly releases impurities. Specifically, a mortar made of alumina with a purity higher than or equal to 90%, preferably higher than or equal to 99% is used. Note that heating conditions equivalent to those in Step S13 can be employed in a later-described heating step other than Step S13.

### <Step S14>

Through the above steps, a composite oxide containing the transition metal (LiMO₂) can be obtained in Step S14 shown in FIG. 7A. The composite oxide needs to have a crystal structure of a lithium-containing composite oxide represented by LiMO₂, but the composition is not strictly limited to Li:M:O=1:1:2. In the case where cobalt is used as the transition metal, the composite oxide is referred to as a composite oxide containing cobalt and is represented by LiCoO₂. Note that the composition is not strictly limited to Li:Co:O=1:1:2.

Although the example is described in which the composite oxide is manufactured by a solid phase method as in Step S11 to Step S14, the composite oxide may be manufactured by a coprecipitation method. Alternatively, the composite oxide may be manufactured by a hydrothermal method.

### <Step S15>

Next, in Step S15 shown in FIG. 7A, the above composite oxide is heated. The heating in Step S15 is the first heating performed on the composite oxide and thus, this heating is sometimes referred to as the initial heating. Through the initial heating, a surface of the composite oxide becomes smooth. A smooth surface refers to a state where the composite oxide has little unevenness on its surface, the composite oxide is rounded as a whole, and a corner portion is rounded. A smooth surface also refers to a surface of the composite oxide to which few foreign matters are attached. Foreign matters are deemed to cause unevenness and are preferably not attached to the surface of the composite oxide.

The present inventors found that performing the initial heating can reduce or inhibit degradation after charging and discharging. The initial heating for making the surface smooth does not need a lithium source. Alternatively, the initial heating for making the surface smooth does not need an additive element source. Alternatively, the initial heating for making the surface smooth does not need a flux agent.

The initial heating is performed before Step S20 described below and is sometimes referred to as preheating or pretreatment.

The lithium source and/or transition metal source prepared in Step S11 and the like might contain impurities. The initial heating can reduce the impurities of the composite oxide completed in Step 14.

The heating conditions in this step can be freely set as long as the heating makes the surface of the above composite oxide smooth. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating in Step S15 is preferably performed at a temperature higher than or equal to 700° C. and lower than or equal to 1000° C. for longer than or equal to 2 hours.

The heating in Step S13 might cause a temperature difference between the surface and an inner portion of the above composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated or relieved by the initial heating in Step S15 and in other words, the distortion energy is probably equalized by the initial heating in Step S15. When the distortion energy is equalized, the distortion in the composite oxide is eliminated or relieved. This is probably why the surface of the composite oxide becomes smooth through Step S15. Obtaining such a smooth surface is also referred to as “improving a surface”. In other words, it is presumable that Step S15 eliminates or reduces the differential shrinkage caused in the composite oxide to make the surface of the composite oxide smooth.

Such differential shrinkage might cause a micro shift in the composite oxide such as a shift in a crystal. To reduce the shift, the heating in Step S15 is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 eliminates or reduces the shift in a crystal or the like which is caused in the composite oxide to make the surface of the composite oxide smooth.

In a secondary battery including a composite oxide with a smooth surface as a positive electrode active material, degradation by charging and discharging is inhibited and cracking of the positive electrode active material can also be prevented.

It can be said that when surface unevenness information in one cross section of a composite oxide is quantified with measurement data, a smooth surface of the composite oxide has a surface roughness at least less than or equal to 10 nm. The one cross section is, for example, a cross section obtained in observation using a STEM (scanning transmission electron microscope).

Note that a pre-synthesized composite oxide containing lithium and a transition metal may be used in Step S14. In that case, Step S11 to Step S13 can be omitted. When Step S15 is performed on the pre-synthesized composite oxide, a composite oxide with a smooth surface can be obtained.

The initial heating might reduce lithium in the composite oxide. An additive element described for Step S20 or the like below might easily enter the composite oxide owing to the reduction in lithium.

Note that the initial heating may be omitted. For example, the initial heating can be omitted in the case where the composite oxide is sufficiently smooth.

### <Step S20>

An additive element X may be added to the composite oxide having a smooth surface as long as a layered rock-salt crystal structure can be obtained. When the additive element X is added to the composite oxide having a smooth surface, the additive element X can be uniformly added. It is thus preferable that the initial heating precede the addition of the additive element. The step of adding the additive element X is described with reference to FIG. 7B and FIG. 7C.

### <Step S21>

In Step S21 shown in FIG. 7B, additive element sources (X sources) to be added to the composite oxide are prepared. In this embodiment, a Mg source and a F source are prepared as the X sources. In Step S21, a lithium source may be prepared in addition to the additive element sources.

As the additive element X, one or two or more elements selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element X, one or more elements selected from bromine and beryllium can be used. Note that the aforementioned additive elements are more favorably used because bromine and beryllium are elements having toxicity to living things.

When magnesium is selected as the additive element X, the additive element source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element X, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. Meanwhile, when the proportion of lithium fluoride increases, the cycling performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value of a given value” means a value greater than 0.9 times and less than 1.1 times the given value.

### <Step S22>

Next, in Step S22 shown in FIG. 7B, the magnesium source and the fluorine source are ground and mixed. For this step, any of the conditions for the grinding and mixing that are described for Step S12 can be selected.

A heating step may be performed after Step S22 as needed. For the heating step after Step S22, any of the heating conditions described for Step S13 can be selected. The heating time after Step S22 is preferably longer than or equal to 2 hours and the heating temperature is preferably higher than or equal to 800° C. and lower than or equal to 1100° C.

### <Step S23>

Next, in Step S23 shown in FIG. 7B, the materials ground and mixed in the above step are collected to give an additive element source (X source). Note that the additive element source in Step S23 is manufactured using a plurality of starting materials and can be referred to as a mixed material or a mixture.

As for the particle diameter of the mixture, its median diameter (D50) is preferably greater than or equal to 600 nm and less than or equal to 20 μm, further preferably greater than or equal to 1 μm and less than or equal to 10 μm. Also when one kind of material is used as the additive element source (X source), the median diameter (D50) is preferably greater than or equal to 600 nm and less than or equal to 20 μm, further preferably greater than or equal to 1 μm and less than or equal to 10 μm.

Such a pulverized mixture (which may contain only one kind of the additive element) is easy to uniformly attach to the surface of the composite oxide obtained in Step S14, in a later step of mixing with the composite oxide. The mixture is preferably attached uniformly to the surface of the composite oxide, in which case fluorine and magnesium are easily distributed or dispersed uniformly in a surface portion of the composite oxide after heating. The region where fluorine and magnesium are distributed can be referred to as a surface portion. It is not desirable for the surface portion to include a region that contains neither fluorine nor magnesium. Note that although fluorine is used in the above description, chlorine may be used instead of fluorine, and a general term “halogen” for these elements can replace “fluorine”.

### <Step S21>

A process different from that in FIG. 7B is described with reference to FIG. 7C. In Step S21 shown in FIG. 7C, four kinds of additive element sources to be added to the composite oxide are prepared. In other words, FIG. 7C is different from FIG. 7B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 7B. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 7C are similar to the steps described with reference to FIG. 7B.

### <Step S31>

Next, in Step S31 shown in FIG. 7A, the composite oxide and the additive element source (X source) are mixed. The ratio of the number Av of the transition metal atoms in the composite oxide containing lithium, the transition metal, and oxygen to the number A_{Mg} of magnesium atoms in the additive element X is preferably Av. A_{Mg}=100:y (0.1≤y≤6), further preferably Av; A_{Mg}=100:y (0.3≤y≤3).

The conditions of the mixing in Step S31 are preferably milder than those of the mixing in Step S12 in order not to damage the composite oxide. For example, conditions with a smaller number of rotations or a shorter time than that for the mixing in Step S12 is preferable. In addition, it can be said that a dry method has a milder condition than a wet method. For example, a ball mill or a bead mill can be used for the mixing. When a ball mill is used, zirconia balls are preferably used as a medium, for example.

In this embodiment, the mixing is performed with a ball mill using zirconia balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 7A, the materials mixed in the above step are collected, whereby a mixture 903 is obtained. At the time of the collection, the materials may be crushed as needed and may be then made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal source in Step S11, i.e., at the stage of the starting materials of the composite oxide. After that, the heating in Step S13 is performed, so that LiMO₂ to which magnesium and fluorine are added can be obtained. In that case, there is no need to separately perform Step S11 to Step S14 and Step S21 to Step S23. This method can be regarded as being simple and highly productive.

Alternatively, lithium cobalt oxide to which magnesium and fluorine are added in advance may be used. When lithium cobalt oxide to which magnesium and fluorine are added is used, Step S11 to Step S32 and Step S20 can be skipped. This method can be regarded as being simple and highly productive.

Alternatively, to lithium cobalt oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 7A, the mixture 903 is heated. Any of the heating conditions described for Step S13 can be selected. The heating time in Step S33 is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element source proceeds. The temperature at which the reaction proceeds is the temperature at which interdiffusion of the elements included in LiMO₂ and the additive element source occurs, and may be lower than the melting temperatures of these materials. It is known that in the case of an oxide as an example, solid phase diffusion occurs at the temperature 0.757 times the melting temperature Tₘ (this temperature is referred to as the Tamman temperature Ta). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included as the additive element sources, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably lower than that in Step 13.

In addition, at the time of heating the mixture 903, the partial pressure of fluorine or a fluoride originating from the fluorine source or the like is preferably controlled to be within an appropriate range.

In the manufacturing method described in this embodiment, some of the materials, e.g., LiF as the fluorine source, function as a fusing agent in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element X such as magnesium in the surface portion and manufacture of the positive electrode active material having excellent characteristics.

However, since LiF in a gas phase has a specific gravity less than that of oxygen, heating might volatilize or sublimate LiF and in that case, LiF in the mixture 903 decreases. As a result, the function of a fusing agent deteriorates. Thus, heating needs to be performed while volatilization or sublimation of LiF is inhibited. Note that even when LiF is not used as the fluorine source or the like, Li at the surface of LiMO₂ and F of the fluorine source might react to produce LiF, which might volatilize or sublimate. Therefore, the volatilization or sublimation needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization or sublimation of LiF in the mixture 903.

The heating in this step is preferably performed such that the mixtures 903 are not adhered to each other. Adhesion of the mixtures 903 during the heating might decrease the area of contact with oxygen in the atmosphere and block a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, the adhesion is preferably prevented in order to allow the surface of the mixture subjected to the heating in Step S15 to maintain smoothness or to be smoother in this step.

In the case of using a rotary kiln for the heating, the flow rate of an oxygen-containing atmosphere in the kiln is preferably controlled. For example, it is preferable that the flow rate of an oxygen-containing atmosphere be set low, or no flowing of oxygen be performed after an oxygen atmosphere is introduced into the kiln, i.e., O₂ purging be performed. In other words, flowing of oxygen might cause evaporation or sublimation of the fluorine source, and O₂ purging is preferably performed to maintain the smoothness of the surface.

In the case of using a roller hearth kiln for the heating, the mixture 903 can be heated in an atmosphere containing LiF with the container containing the mixture 903 covered with a lid, for example.

A supplementary explanation of the heating time in Step S33 is provided. The heating time is changed depending on conditions such as the heating temperature and the size and composition of LiMO₂ in Step S14. In the case where the particle diameter is small, the heating is preferably performed at a lower temperature or for a shorter time than heating of the case where the particle diameter is large, in some cases.

In the case where the composite oxide (LiMO₂) in Step S14 in FIG. 7A has a median diameter (D50) of approximately 12 μm, the heating temperature in Step S33 is preferably higher than or equal to 600° C. and lower than or equal to 950° C., for example. The heating time in Step S33 is preferably longer than or equal to 3 hours, further preferably longer than or equal to 10 hours, still further preferably longer than or equal to 60 hours, for example. Note that the time for lowering the temperature after the heating in Step S33 is preferably longer than or equal to 10 hours and shorter than or equal to 50 hours, for example.

In the case where the composite oxide (LiMO₂) in Step S14 has a median diameter (D50) of approximately 5 μm, the heating temperature in Step S33 is preferably higher than or equal to 600° C. and lower than or equal to 950° C., for example. The heating time in Step S33 is preferably longer than or equal to 1 hour and shorter than or equal to 10 hours, further preferably approximately 2 hours, for example. Note that the time for lowering the temperature after the heating in Step S33 is preferably longer than or equal to 10 hours and shorter than or equal to 50 hours, for example.

### <Step S34>

Next, the heated material is collected in Step S34 shown in FIG. 7A, in which crushing is performed as needed; thus, the positive electrode active material 100 is obtained. Here, the collected particles are preferably made to pass through a sieve. Through the above process, the positive electrode active material 100 of one embodiment of the present invention can be manufactured. The positive electrode active material of one embodiment of the present invention has a smooth surface.

### <<Manufacturing Method 2 of Positive Electrode Active Material>>

Next, as one embodiment of the present invention, a method different from Manufacturing method 1 of the positive electrode active material is described.

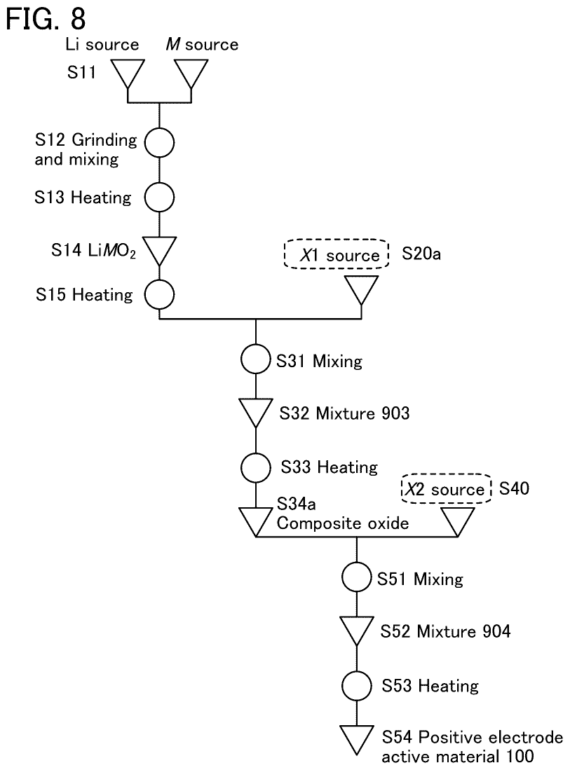

Steps S11 to S15 in FIG. 8 are performed as in FIG. 7A to prepare a composite oxide (LiMO₂) having a smooth surface.

### <Step S20a>

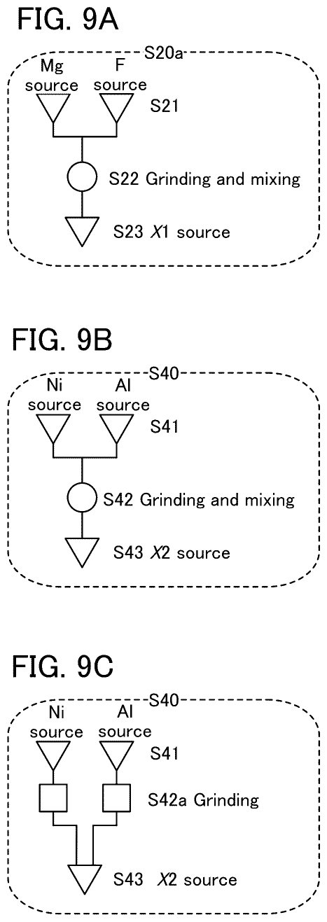

As already described above, the additive element X may be added to the composite oxide as long as a layered rock-salt crystal structure can be obtained. Manufacturing method 2 has two or more steps of adding the additive element X, as described below with reference to FIG. 9A.

### <Step S21>

In Step S21 shown in FIG. 9A, a first additive element source (X1 source) is prepared. The X1 source can be selected from the additive elements X described for Step S21 with reference to FIG. 7B to be used. For example, one or more selected from magnesium, fluorine, and calcium can be suitably used as the additive element X1. FIG. 9A shows an example of using a magnesium source (Mg source) and a fluorine source (F source) as the additive element X1 sources.

Step S21 to Step S23 shown in FIG. 9A can be performed under the conditions similar to those in Step S21 to Step S23 shown in FIG. 7B. As a result, the additive element source (X1 source) can be obtained in Step S23.

Steps S31 to S33 shown in FIG. 8 can be performed in a manner similar to that of Steps S31 to S33 shown in FIG. 7A.

### <Step S34a>

Next, the material heated in Step S33 is collected to manufacture a composite oxide containing the additive element X1. This composite oxide is called a second composite oxide to be distinguished from the composite oxide in Step S14.

### <Step S40>

In Step S40 shown in FIG. 8, a second additive element source (X2 source) is added. FIG. 9B and FIG. 9C are referred to in the following description.

### <Step S41>

In Step S41 shown in FIG. 9B, the second additive element source (X2 source) is prepared. The X2 source can be selected from the additive elements X described for Step S21 with reference to FIG. 7B to be used. For example, one or two or more selected from nickel, titanium, boron, zirconium, and aluminum can be suitably used as the additive element X2. FIG. 9B shows an example of using nickel and aluminum as the additive elements X2.

Step S41 to Step S43 shown in FIG. 9B can be performed under the conditions similar to those in Step S21 to Step S23 shown in FIG. 7B. As a result, the additive element source (X2) can be obtained in Step S43.

FIG. 9C shows a modification example described with reference to FIG. 9B. A nickel source (Ni source) and an aluminum source (Al source) are prepared in Step S41 shown in FIG. 9C and are separately ground in Step S42a. The step in FIG. 9C is different from the step in FIG. 9B in separately grinding the additive elements in Step S42a. Accordingly, a plurality of the second additive element sources are prepared in Step S43.

### <Step S51 to Step S54>

Next, Step S51 to Step S53 shown in FIG. 8 can be performed under the conditions similar to those in Step S31 to Step S34 shown in FIG. 7A. The mixture obtained in Step S52 is a mixture 904. The heating in Step S53 can be performed at a lower temperature and for a shorter time than the heating in Step S33. Through the above steps, the positive electrode active material 100 of one embodiment of the present invention can be manufactured in Step S54. The positive electrode active material of one embodiment of the present invention has a smooth surface.

As shown in FIG. 8 and FIG. 9, in Manufacturing method 2, introduction of the additive element to the composite oxide is separated into introduction of the first additive element X1 and that of the second additive element X2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion.

The initial heating described in this embodiment makes it possible to obtain a positive electrode active material having a smooth surface.

The initial heating described in this embodiment is performed on a composite oxide. Thus, the initial heating is preferably performed at a temperature lower than the heating temperature for forming the composite oxide and for a time shorter than the heating time for forming the composite oxide. In the case of adding the additive element to the composite oxide, the adding step is preferably performed after the initial heating. The adding step may be separated into two or more steps. The steps are preferably performed in such an order to maintain the smoothness of the surface achieved by the initial heating. When a composite oxide contains cobalt as a transition metal, the composite oxide can be read as a composite oxide containing cobalt.

This embodiment can be used in combination with any of the other embodiments.

### Embodiment 4

In this embodiment, a positive electrode active material of one embodiment of the present invention is described.

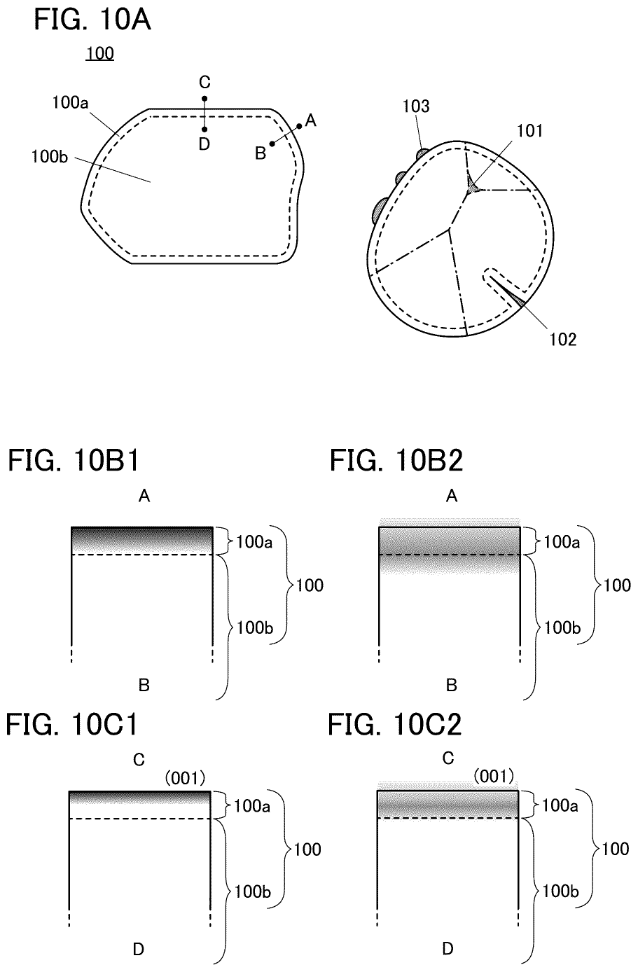

FIG. 10A is a cross-sectional view of the positive electrode active material 100 of one embodiment of the present invention. The positive electrode active material 100 is in a state just after its manufacture in accordance with the above embodiment but at least before pressing. Thus, illustration of a crack, a pit, and a closed split is omitted. FIG. 10B1 and FIG. 10B2 show enlarged views of a portion near the line A-B in FIG. 10A. FIG. 10C1 and FIG. 10C2 show enlarged views of a portion near the line C-D in FIG. 10A.

As illustrated in FIG. 10A to FIG. 10C2, the positive electrode active material 100 includes a surface portion 100a and an inner portion 100b. In each drawing, the dashed line denotes a boundary between the surface portion 100a and the inner portion 100b. The surface portion 100a is a region extending from a surface of the positive electrode active material to a depth of 10 nm toward the inner portion. The surface sometimes includes the surface newly formed by a crack. The surface portion 100a is referred to as the vicinity of a surface, a region in the vicinity of a surface, or a shell in some cases. The inner portion 100b refers to a region deeper than the surface portion 100a of the positive electrode active material. The inner portion 100b is referred to as an inner region or a core in some cases.

In the right diagram in FIG. 10A, the dashed-dotted line denotes part of a crystal grain boundary 101.

The surface portion 100a preferably has a higher concentration of the additive element than the inner portion 100b. The additive element preferably has a concentration gradient. In the case where a plurality of additive elements are included, the additive elements preferably exhibit concentration peaks at different depths from a surface.

For example, an additive element A preferably has a concentration gradient as illustrated by gradation in FIG. 10B1, in which the concentration increases from the inner portion 100b toward a surface. Examples of the additive element A that preferably has such a concentration gradient include magnesium, fluorine, titanium, silicon, phosphorus, boron, and calcium.

Another additive element B preferably has a concentration gradient as illustrated by gradation in FIG. 10B2 and exhibits a concentration peak at a deeper region than the concentration peak in FIG. 10B1. The concentration peak may be located in the surface portion 100a or located deeper than the surface portion 100a. The concentration peak is preferably located in a region other than an outermost surface layer. For example, the concentration peak is preferably located in a region extending, toward the inner portion, from a depth from the surface of 5 nm to a depth from the surface of 30 nm. Examples of the additive element B that preferably has such a concentration gradient include aluminum and manganese.

It is preferable that the crystal structure continuously change from the inner portion 100b toward a surface owing to the above-described concentration gradient of the additive element.

### <Contained Elements>

The positive electrode active material 100 contains lithium, the transition metal M, oxygen, and an additive element. The positive electrode active material 100 can be regarded as a composite oxide represented by LiMO₂ to which an additive element is added. Note that the positive electrode active material of one embodiment of the present invention only needs to have a crystal structure of a lithium-containing composite oxide represented by LiMO₂, but the composition is not strictly limited to Li:M:O=1:1:2. In some cases, a positive electrode active material to which an additive element is added is referred to as a composite oxide.

Using cobalt at higher than or equal to 75 at %, preferably higher than or equal to 90 at %, further preferably higher than or equal to 95 at % as the transition metal M contained in the positive electrode active material 100 brings many advantages such as relatively easy synthesis, easy handling, and excellent cycling performance. Moreover, when nickel is contained as the transition metal M in addition to cobalt in the above range, a shift in a layered structure formed of octahedrons of cobalt and oxygen is sometimes inhibited. The inhibition of the shift enables higher stability of the crystal structure particularly in a high-temperature charged state in some cases, which is preferable.

Note that manganese is not necessarily contained as the transition metal M. When the positive electrode active material 100 is substantially free from manganese, the above advantages such as relatively easy synthesis, easy handling, and excellent cycling performance are sometimes enhanced. The weight of manganese contained in the positive electrode active material 100 is preferably less than or equal to 600 ppm, further preferably less than or equal to 100 ppm, for example.

Using nickel at greater than or equal to 33 at %, preferably greater than or equal to 60 at %, further preferably greater than or equal to 80 at % as the transition metal M contained in the positive electrode active material 100 is preferable because in that case, the cost of the raw materials might be lower than that in the case of using a large amount of cobalt and a discharge capacity per weight might be increased.

Note that nickel is not necessarily contained as the transition metal M.

The additive element contained in the positive electrode active material 100 can be selected from the additive elements described in the above embodiment.

In order to prevent the breakage of a layered structure formed of octahedrons of the transition metal M and oxygen even when lithium is extracted from the positive electrode active material 100 of one embodiment of the present invention by charging, the surface portion 100a having a high concentration of the additive element, i.e., the outer portion of a particle, is reinforced.

The added-element concentration gradient is preferably similar throughout the surface portion 100a of the positive electrode active material 100. In other words, it is preferable that the reinforcement derived from the high impurity concentration uniformly occurs in the surface portion 100a. When the surface portion 100a partly has reinforcement, stress might be concentrated on parts that do not have reinforcement. The concentration of stress on part of a particle might cause a defect, leading to degraded cycling performance.

Note that the additive elements do not necessarily have similar concentration gradients throughout the surface portion 100a of the positive electrode active material 100. For example, the additive elements may have different concentration gradients as shown in FIG. 10C1 and FIG. 10C2.

Here, the portion near the line C-D has a layered rock-salt crystal structure belonging to R-3m and the surface of the portion has a (001) orientation. The distribution of the additive element in the surface having a (001) orientation may be different from that at other surfaces. For example, at least one of the additive element A and the additive element B may be distributed shallower from the surface having a (001) orientation and the surface portion 100a thereof than from a surface having an orientation other than a (001) orientation. Alternatively, the surface having a (001) orientation and the surface portion 100a thereof may have a lower concentration of at least one of the additive element A and the additive element B than a surface having an orientation other than a (001) orientation. Further alternatively, at the surface with a (001) orientation and the surface portion 100a thereof, the concentration of at least one of the additive element A and the additive element B may be below the lower detection limit.

In a layered rock-salt crystal structure belonging to R-3m, cations are arranged parallel to the (001) plane. In other words, an MO₂ layer formed of octahedrons of the transition metal M and oxygen and a lithium layer are alternately stacked parallel to the (001) plane. Accordingly, a diffusion path of lithium ions also exists parallel to a (001) plane.

Since an MO₂ layer formed of octahedrons of the transition metal M and oxygen is relatively stable, the (001) plane having the MO₂ layer in the surface is relatively stable. A diffusion path of lithium ions is not exposed at the (001) plane.

By contrast, a diffusion path of lithium ions is exposed at a surface having an orientation other than a (001) orientation. Thus, the surface with an orientation other than a (001) orientation and the surface portion 100a thereof easily lose stability because they are regions where extraction of lithium ions starts as well as important regions for maintaining a diffusion path of lithium ions. It is thus preferable to reinforce the surface with an orientation other than a (001) orientation and the surface portion 100a thereof so that the crystal structure of the whole positive electrode active material 100 is maintained.

In the manufacturing methods as described in the above embodiment, in which high-purity LiMO₂ is manufactured, the additive element is mixed afterwards, and heating is performed, the additive element spreads mainly through a diffusion path of lithium ions and thus, the distribution of the additive element in the surface with an orientation other than a (001) orientation and the surface portion 100a thereof can easily fall within a preferable range.

By the manufacturing method which is described in the above embodiment and in which high-purity LiMO₂ is manufactured, the additive element is then mixed, and heating is performed, the distribution of the additive element in the surface with an orientation other than a (001) orientation and the surface portion 100a thereof can be favorable as compared with the distribution of the additive element in a (001) plane. Moreover, in the manufacturing method involving the initial heating, lithium atoms in the surface portion are expected to be extracted from LiMO₂ owing to the initial heating and thus, the additive element such as magnesium atoms can be probably distributed more easily in the surface portion at a high concentration.

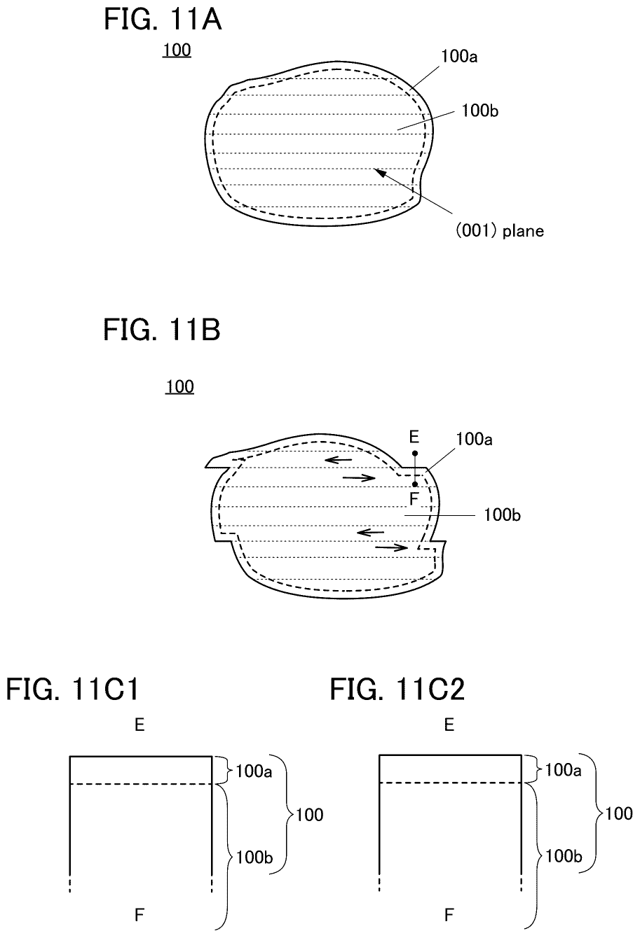

The positive electrode active material 100 preferably has a smooth surface with little unevenness. In a composite oxide with a layered rock-salt crystal structure belonging to R-3m, slipping easily occurs at a plane parallel to a (001) plane that is a crystal plane, e.g., a plane where lithium atoms are arranged. Slipping might occur when, for example, a positive electrode mixture is pressed. In the case where a (001) plane is horizontal as shown in FIG. 11A, steps such as a pressing step sometimes cause slipping in a horizontal direction as denoted by arrows in FIG. 11B, resulting in deformation. Pressing may be performed a plurality of times.

In this case, at a surface newly formed as a result of slipping and the surface portion 100a thereof, the additive element is not present or the concentration of the additive element is below the lower detection limit in some cases. The line E-F in FIG. 11B denotes examples of the surface newly formed as a result of slipping and its surface portion 100a. FIG. 11C1 and FIG. 11C2 show enlarged views of the vicinity of the line E-F. In FIG. 11C1 and FIG. 11C2, there exists neither gradation of the additive element A nor that of the additive element B, unlike in FIG. 10B1 to FIG. 10C2.

However, because slipping easily occurs parallel to a (001) plane, the newly formed surface and the surface portion 100a thereof have a (001) orientation. Since a diffusion path of lithium ions is not exposed at a (001) plane and the (001) plane is relatively stable, substantially no problem is caused even when the additive element is not present or the concentration of the additive element is below the lower detection limit.

Note that as described above, in a composite oxide whose composition is LiMO₂ and which has a layered rock-salt crystal structure belonging to R-3m, cations are arranged parallel to a (001) plane. In a HAADF-STEM image, the luminance of the transition metal M, which has the largest atom number in LiMO₂, is the highest. Thus, in a HAADF-STEM image, arrangement of atoms with a high luminance may be regarded as arrangement of atoms of the transition metal M. Repetition of such arrangement with a high luminance may be referred to as crystal fringes or lattice fringes. Such crystal fringes or lattice fringes may be deemed to be parallel to a (001) plane in the case of a layered rock-salt crystal structure belonging to R-3m.

The positive electrode active material 100 sometimes has defects, and when charging and discharging are repeated, elution of the transition metal M, breakage of the crystal structure, cracking of a main body, release of oxygen, or the like might be derived from these defects. However, when there is a filling portion 102 in FIG. 10A that fills such defects, elution of the transition metal M or the like can be inhibited. Thus, the positive electrode active material 100 can have high reliability and enable excellent cycling performance.

The positive electrode active material 100 may include a projection 103, which is a region where the additive element is unevenly distributed.

As described above, an excessive amount of the additive element in the positive electrode active material 100 might adversely affect insertion and extraction of lithium. The use of such a positive electrode active material 100 for a secondary battery might cause an internal resistance increase, a discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b, so that the additive element concentration can be appropriate in the inner portion 100b. This can inhibit an internal resistance increase, a discharge capacity decrease, and the like when the positive electrode active material 100 is used for a secondary battery: A feature of inhibiting an internal resistance increase in a secondary battery is extremely preferable especially in charging and discharging at a high rate such as charging and discharging at 2 C or more.

Magnesium, which is an example of the additive element A, is divalent and is more stable in lithium sites than in transition metal sites in a layered rock-salt crystal structure; thus, magnesium is likely to enter the lithium sites. An appropriate concentration of magnesium in the lithium sites of the surface portion 100a can facilitate maintenance of the layered rock-salt crystal structure. Magnesium can inhibit extraction of oxygen around magnesium when the charge depth is large. Magnesium is also expected to increase the density of the positive electrode active material. An appropriate concentration of magnesium does not have an adverse effect on insertion or extraction of lithium in charging and discharging, and is thus preferable. However, excess magnesium might adversely affect insertion and extraction of lithium. Thus, as will be described later, the concentration of the transition metal M is preferably higher than that of magnesium in the surface portion 100a, for example.

Aluminum, which is an example of the additive element B, is trivalent and can exist at a transition metal site in a layered rock-salt crystal structure. Aluminum can inhibit elution of surrounding cobalt. The bonding strength of aluminum with oxygen is high, thereby inhibiting extraction of oxygen around aluminum. Hence, aluminum contained as the additive element enables the positive electrode active material 100 to have the crystal structure that is unlikely to be broken by repeated charging and discharging.

When fluorine, which is a monovalent anion, is substituted for part of oxygen in the surface portion 100a, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion 100a of the positive electrode active material 100, lithium ions near fluorine are likely to be extracted and inserted smoothly. Thus, such a positive electrode active material 100 is preferably used in a secondary battery, in which case the charge and discharge characteristics, rate performance, and the like are improved.

Titanium oxide is known to have superhydrophilicity. Accordingly, the positive electrode active material 100 that includes titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can inhibit a discharge capacity decrease due to repeated charging and discharging.

A short circuit of a secondary battery might cause not only a malfunction in charging operation and/or discharging operation of the secondary battery but also heat generation and ignition. In order to obtain a safe secondary battery, a short-circuit current is preferably inhibited even at a high charge voltage. In the positive electrode active material 100 of one embodiment of the present invention, a short-circuit current is inhibited even at a high charge voltage. Thus, a secondary battery having a high discharge capacity and a high level of safety can be obtained.

The concentration gradient of the additive element can be evaluated using energy dispersive X-ray spectroscopy (EDX), EPMA (electron probe microanalysis), or the like. In the EDX measurement, to measure a region while scanning is performed and evaluate the region two-dimensionally is referred to as EDX area analysis. The measurement by line scan, which is performed to evaluate the atomic concentration distribution in a positive electrode active material particle, is referred to as line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed.

When the positive electrode active material 100 containing magnesium as the additive element is subjected to the EDX line analysis, a peak of the magnesium concentration in the surface portion 100a is preferably observed in a region extending, toward the center of the positive electrode active material 100, from the surface thereof to a depth of 3 nm, further preferably 1 nm, still further preferably 0.5 nm.

When the positive electrode active material 100 contains magnesium and fluorine as the additive elements, the distribution of fluorine preferably overlaps with the distribution of magnesium. Thus, in the EDX line analysis, a peak of the fluorine concentration in the surface portion 100a is preferably observed in a region extending, toward the center of the positive electrode active material 100, from the surface thereof to a depth of 3 nm, further preferably 1 nm, still further preferably 0.5 nm.

Note that the concentration distribution may differ between the additive elements. For example, in the case where the positive electrode active material 100 contains aluminum as the additive element, the distribution of aluminum is preferably slightly different from that of magnesium and that of fluorine as described above. For example, in the EDX line analysis, the peak of the magnesium concentration is preferably closer to the surface than the peak of the aluminum concentration is in the surface portion 100a. For example, the peak of the aluminum concentration is preferably present in a region extending, toward the center of the positive electrode active material 100, from a depth from the surface of 0.5 nm to a depth from the surface of 50 nm, further preferably from a depth from the surface of 5 nm to a depth from the surface of 30 nm. Alternatively, the peak of the aluminum concentration is preferably present in a region extending, toward the center of the positive electrode active material 100, from a depth from the surface of 0.5 nm to a depth from the surface of 30 nm. Further alternatively, the peak of the aluminum concentration is preferably present in a region extending, toward the center of the positive electrode active material 100, from a depth from the surface of 5 nm to a depth from the surface of 50 nm.

When the positive electrode active material 100 is subjected to line analysis or area analysis, the ratio of the number of atoms of an additive element/to the number of atoms of the transition metal M (I/M) in the surface portion 100a is preferably higher than or equal to 0.05 and lower than or equal to 1.00. When the additive element is titanium, the ratio of the number of atoms of titanium to the number of atoms of the transition metal M (Ti/M) is preferably higher than or equal to 0.05 and lower than or equal to 0.4, further preferably higher than or equal to 0.1 and lower than or equal to 0.3. When the additive element is magnesium, the ratio of the number of atoms of magnesium to the number of atoms of the transition metal M (Mg/M) is preferably higher than or equal to 0.4 and lower than or equal to 1.5, further preferably higher than or equal to 0.45 and lower than or equal to 1.00. When the impurity element is fluorine, the ratio of the number of atoms of fluorine to the number of atoms of the transition metal M (F/M) is preferably higher than or equal to 0.05 and lower than or equal to 1.5, further preferably higher than or equal to 0.3 and lower than or equal to 1.00.

According to results of the EDX line analysis, where a surface of the positive electrode active material 100 is can be estimated in the following manner. A point where the detected amount of an element which uniformly exists in the inner portion 100b of the positive electrode active material 100, e.g., oxygen or the transition metal M such as cobalt, is ½ of the detected amount thereof in the inner portion 100b is assumed as the surface.

Since the positive electrode active material 100 is a composite oxide, the detected amount of oxygen is preferably used to estimate where the surface is. Specifically, an average value Oₐᵥₑ of the oxygen concentration of a region of the inner portion 100b where the detected amount of oxygen is stable is calculated first. At this time, in the case where oxygen O_{background} which is probably led from chemical adsorption or the background is detected in a region that is obviously outside the surface, O_{background} can be subtracted from the measurement value to obtain the average value Oₐᵥₑ of the oxygen concentration. The measurement point where the measurement value which is closest to ½ of the average value Oₐᵥₑ, or ½Oₐᵥₑ, is obtained can be estimated to be the surface of the positive electrode active material.

Where the surface is can also be estimated with the use of the transition metal M contained in the positive electrode active material 100. For example, in the case where 95% or more of the transition metals M is cobalt, the detected amount of cobalt can be used to estimate where the surface is as in the above description. Alternatively, the sum of the detected amounts of the transition metals M can be used for the estimation in a similar manner. The detected amount of the transition metal M is unlikely to be affected by chemical adsorption and is thus suitable for the estimation of where the surface is.

When the positive electrode active material 100 is subjected to line analysis or area analysis, the ratio of the number of atoms of the additive element/to the number of atoms of the transition metal M (I/M) in the vicinity of the crystal grain boundary 101 is preferably higher than or equal to 0.020 and lower than or equal to 0.50, further preferably higher than or equal to 0.025 and lower than or equal to 0.30, still further preferably higher than or equal to 0.030 and lower than or equal to 0.20. Alternatively, the ratio is preferably higher than or equal to 0.020 and lower than or equal to 0.30, higher than or equal to 0.020 and lower than or equal to 0.20, higher than or equal to 0.025 and lower than or equal to 0.50, higher than or equal to 0.025 and lower than or equal to 0.20, higher than or equal to 0.030 and lower than or equal to 0.50, or higher than or equal to 0.030 and lower than or equal to 0.30.

For example, when the additive element is magnesium and the transition metal M is cobalt, the ratio of the number of magnesium atoms to the number of cobalt atoms (Mg/Co) is preferably higher than or equal to 0.020 and lower than or equal to 0.50, further preferably higher than or equal to 0.025 and lower than or equal to 0.30, still further preferably higher than or equal to 0.030 and lower than or equal to 0.20. Alternatively, the ratio is preferably higher than or equal to 0.020 and lower than or equal to 0.30, higher than or equal to 0.020 and lower than or equal to 0.20, higher than or equal to 0.025 and lower than or equal to 0.50, higher than or equal to 0.025 and lower than or equal to 0.20, higher than or equal to 0.030 and lower than or equal to 0.50, or higher than or equal to 0.030 and lower than or equal to 0.30.

The positive electrode active material 100 may include a coating film in at least part of its surface. The coating film is preferably formed by deposition of a decomposition product of an electrolyte solution due to charging and discharging, for example. A coating film originating from an electrolyte solution, which is formed on the surface of the positive electrode active material 100, is expected to improve cycling test performance particularly when charging with a large charge depth is repeated. This is because an increase in impedance of the surface of the positive electrode active material is inhibited or elution of the transition metal M is inhibited, for example. The coating film preferably contains carbon, oxygen, and fluorine, for example. The coating film can have high quality easily when part of the electrolyte solution includes LiBOB and/or suberonitrile (SUN), for example. Accordingly, the coating film preferably contains at least one of boron, nitrogen, sulfur, and fluorine to possibly have high quality. The coating film does not necessarily cover the positive electrode active material 100 entirely.

When the magnesium concentration is higher than a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably greater than or equal to 0.001 times and less than or equal to 0.1 times, further preferably greater than 0.01 times and less than 0.04 times, still further preferably approximately 0.02 times the number of atoms of the transition metal M. Alternatively, the number of magnesium atoms is preferably greater than or equal to 0.001 times and less than 0.04 times the number of atoms of the transition metal M. Alternatively, the number of magnesium atoms is preferably greater than or equal to 0.01 times and less than or equal to 0.1 times the number of atoms of the transition metal M. The magnesium concentration described here may be a value obtained by element analysis on the entire particles of the positive electrode active material by ICP-MS or the like, or may be a value based on the ratio of the raw materials mixed in the process of manufacturing the positive electrode active material, for example.

Aluminum and the transition metal M typified by nickel preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the discharge capacity of the positive electrode active material decreases in some cases. For example, one reason is that the amount of lithium that contributes to charging and discharging decreases when magnesium enters the lithium sites. Another possible reason is that excess magnesium generates a magnesium compound that does not contribute to charging or discharging. When the positive electrode active material of one embodiment of the present invention contains nickel as a metal Z in addition to magnesium, the discharge capacity per weight and per volume can be increased in some cases. When the positive electrode active material of one embodiment of the present invention contains aluminum as the metal Z in addition to magnesium, the discharge capacity per weight and per volume can be increased in some cases. When the positive electrode active material of one embodiment of the present invention contains nickel and aluminum in addition to magnesium, the discharge capacity per weight and per volume can be increased in some cases.

### <<Grain Boundary>>

It is further preferable that the additive element contained in the positive electrode active material 100 of one embodiment of the present invention have the above-described distribution and be partly segregated in the crystal grain boundary 101 and the vicinity thereof as shown in FIG. 10A.

Specifically, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the positive electrode active material 100. Thus, the higher the magnesium concentration at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101. Thus, the positive electrode active material including a crack can also have an increased corrosion resistance to hydrofluoric acid.

Note that in this specification and the like, the vicinity of the crystal grain boundary 101 refers to a region extending approximately 10 nm from the crystal grain boundary 101. The crystal grain boundary refers to a plane where atomic arrangement is changed and which can be observed in an electron microscope image. Specifically, the crystal grain boundary 101 refers to a portion where the angle formed by repetition of bright lines and dark lines in an electron microscope image exceeds 5° or a portion where a crystal structure cannot be observed in an electron microscope image.

### <<Particle Diameter>>

When the positive electrode active material 100 of one embodiment of the present invention has too large a particle diameter, there are problems such as difficulty in lithium diffusion and too large a surface roughness of a layer of a mixture (sometimes referred to as a mixture layer) at the time of coating on a current collector. By contrast, too small a particle diameter causes problems such as difficulty in loading of the mixture layer at the time of coating on the current collector and an overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 μm and less than or equal to 30 μm, greater than or equal to 5 μm and less than or equal to 100 μm, or greater than or equal to 5 μm and less than or equal to 40 μm.

### <<XPS>>

A region that extends from a surface to a depth of approximately 2 nm to 8 nm (normally, less than or equal to 5 nm) can be analyzed by X-ray photoelectron spectroscopy (XPS). The concentrations of elements in a region to the above depth of the surface portion 100a can be quantitatively analyzed. The bonding states of the elements can be analyzed by narrow scanning. Note that the quantitative accuracy of XPS is approximately +1 atomic % in many cases. The lower detection limit is approximately 1 atomic % but depends on the element.

When the positive electrode active material 100 of one embodiment of the present invention is subjected to XPS analysis, the number of atoms of the additive element is preferably greater than or equal to 1.6 times and less than or equal to 6.0 times, further preferably greater than or equal to 1.8 times and less than 4.0 times the number of atoms of the transition metal M. When the additive is magnesium and the transition metal M is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal M.

In the XPS analysis, monochromatic aluminum can be used as an X-ray source, for example. An extraction angle is, for example, 45°. For example, the measurement can be performed using the following apparatus and conditions.
Measurement device: Quantera II produced by PHI, Inc.
X-ray source: monochromatic Al (1486.6 eV)
Detection area: 100 μm φ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably at approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additive elements that preferably exist in the surface portion 100a in a large amount, such as magnesium and aluminum, measured by XPS or the like are preferably higher than the concentrations measured by ICP-MS (inductively coupled plasma mass spectrometry), GD-MS (glow discharge mass spectrometry), or the like.

When a cross section is exposed by processing and analyzed by TEM-EDX, the concentrations of magnesium and aluminum in the surface portion 100a are preferably higher than those in the inner portion 100b. For example, in the TEM-EDX analysis, the magnesium concentration preferably attenuates, at a depth of 1 nm from a point where the concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. An FIB (Focused Ion Beam) can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the ratio of the number of magnesium atoms (Mg/Co) is preferably higher than or equal to 0.001 and lower than or equal to 0.06.

By contrast, it is preferable that nickel, which is one of the transition metals M, not be unevenly distributed in the surface portion 100a but be distributed in the entire positive electrode active material 100. Note that one embodiment of the present invention is not limited thereto in the case where the above-described region where the additive element is unevenly distributed exists.

### <<Surface Roughness>>

The positive electrode active material 100 of one embodiment of the present invention preferably has a smooth surface with little unevenness. A smooth surface with little unevenness indicates favorable distribution of the additive element in the surface portion 100a.

A smooth surface with little unevenness can be recognized from, for example, a cross-sectional SEM image or a cross-sectional TEM image of the positive electrode active material 100 or the specific surface area of the positive electrode active material 100.

This embodiment can be used in combination with any of the other embodiments.

### Embodiment 5

In this embodiment, a positive electrode mixture of one embodiment of the present invention is described.

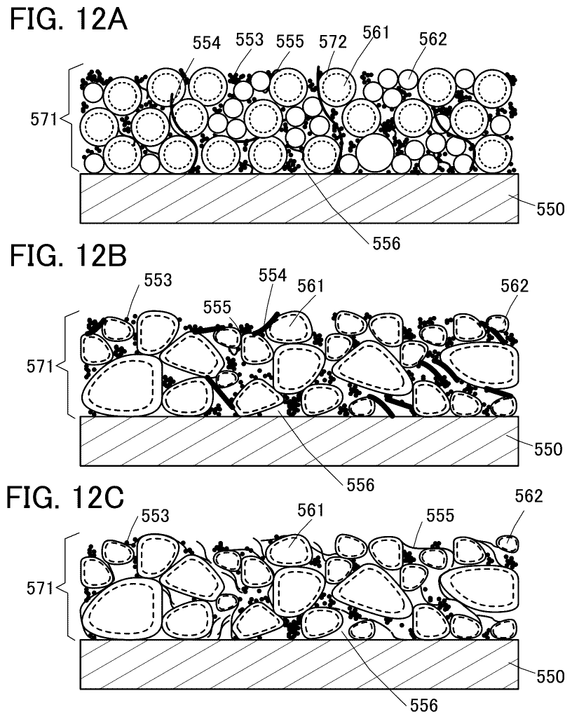

FIG. 12A shows a cross-sectional view of a positive electrode mixture layer 571 with which a current collector 550 is coated. The positive electrode mixture layer 571 contains a positive electrode active material 561. It is preferable that the positive electrode mixture layer 571 further contain a positive electrode active material 562 whose grain diameter is different from that of the positive electrode active material 561 to improve the electrode density. The positive electrode active material 561, which has a larger grain diameter, preferably has a grain diameter that is greater than or equal to 6.5 times and less than or equal to 8.5 times the grain diameter of the positive electrode active material 562, which has a smaller grain diameter.

Description is made on the relationship between a grain diameter and an electrode density, referring to a median diameter. First, the positive electrode active material 562 having a median diameter (D50) of 3 μm and the positive electrode active material 561 having a median diameter (D50) of 21 μm are prepared. Such positive electrode active materials can be obtained through classification using a classifier.

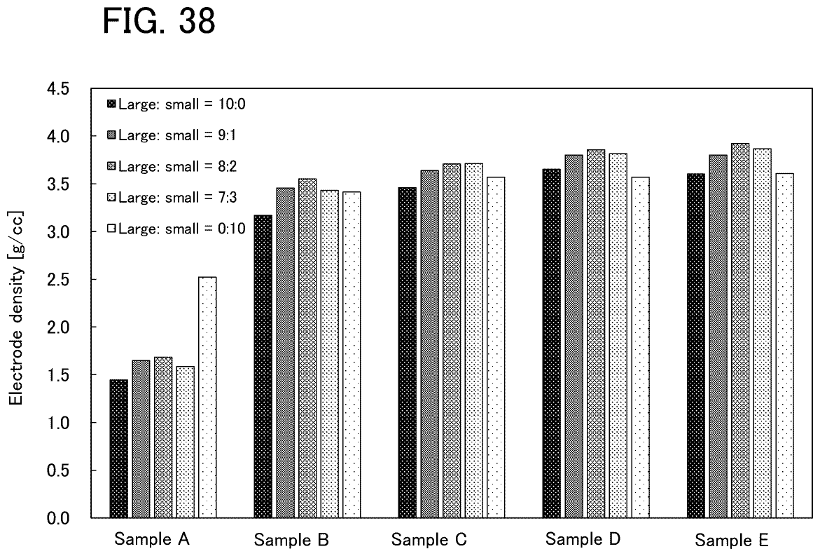

FIG. 38 shows a change in electrode density when the ratio of the positive electrode active material 561 with a large median diameter (D50) to the positive electrode active material 562 with a small median diameter (D50) changes from 10:0 to 9:1, 8:2, 7:3, and 0:10.

In addition, the conditions of the samples in FIG. 38 are different in pressing pressure. The table below shows the pressing pressure conditions of the samples.

TABLE 1

| | Pressing pressure (kN/m) |
|---|---|
| Sample A | No pressing |
| Sample B | 210 |
| Sample C | 210→461 |
| Sample D | 210→461→964 |
| Sample E | 210→461→964→1467 |

From FIG. 38, the electrode density is found to be high when the ratio of the median diameter (large) to the median diameter (small) is 8:2. Moreover, it is found that under any of the pressures, i.e., in each of Sample A to Sample E, the electrode density is high when the ratio of the median diameter (large) to the median diameter (small) is 8:2.

In order that the electrode density can be increased by using a positive electrode active material in which the median diameter (large) is greater than or equal to 6.5 times and less than or equal to 8.5 times (e.g., 7 times) the median diameter (small), the ratio of the median diameter (large) to the median diameter (small) is preferably 8:2.

The positive electrode active material 561 or the positive electrode active material 562 can be manufactured in accordance with the above embodiment and the like. In FIG. 12A, dotted lines each indicate an example of a boundary between an inner portion and a surface portion 572 of the positive electrode active material 561. In the positive electrode active material 561 that includes the surface portion 572, the surface portion can be regarded as corresponding to a shell and the inner portion can be regarded as corresponding to a core, and the positive electrode active material 561 that includes the surface portion 572 is sometimes referred to as a positive electrode active material having a core-shell structure. The positive electrode active material 562 may have a core-shell structure. A positive electrode active material having a core-shell structure is preferable because it does not easily degrade even after high-voltage charging.

The positive electrode mixture layer 571 contains a conductive additive 553. The conductive additive 553 is particulate and can be carbon black or the like. The positive electrode mixture layer 571 may further contain a needle-shaped conductive additive 554, which can be carbon nanotube or the like.

The positive electrode mixture layer 571 contains a binding agent 555, which can be PVDF or the like.

The positive electrode mixture layer 571 includes pores 556. The proportion of pores can be called the porosity of a positive electrode, and the porosity is preferably higher than or equal to 8% and lower than or equal to 35%, further preferably higher than or equal to 12% and lower than or equal to 29%. The pores 556 in the positive electrode mixture layer 571 are impregnated with an electrolyte solution, which does not affect the above porosity of the positive electrode.

Although FIG. 12A shows the positive electrode active material 561 in particle form, the positive electrode active material 561 is not necessarily in particle form. As shown in FIG. 12B, the cross-sectional shape of the positive electrode active material 561 may be an ellipse, a rectangle, a trapezoid, a pyramid, a quadrilateral with rounded corners, or an asymmetrical shape. Note that by pressing in the manufacturing process of the positive electrode, the particulate positive electrode active material sometimes changes in shape to have the shape as shown in FIG. 12B. FIG. 12C shows an example of the case where the conductive additive 554 in FIG. 12B is omitted and only the conductive additive 553 is used.

This embodiment can be used in combination with any of the other embodiments.

### Embodiment 6

In this embodiment, a structure of an all-solid-state battery will be described.

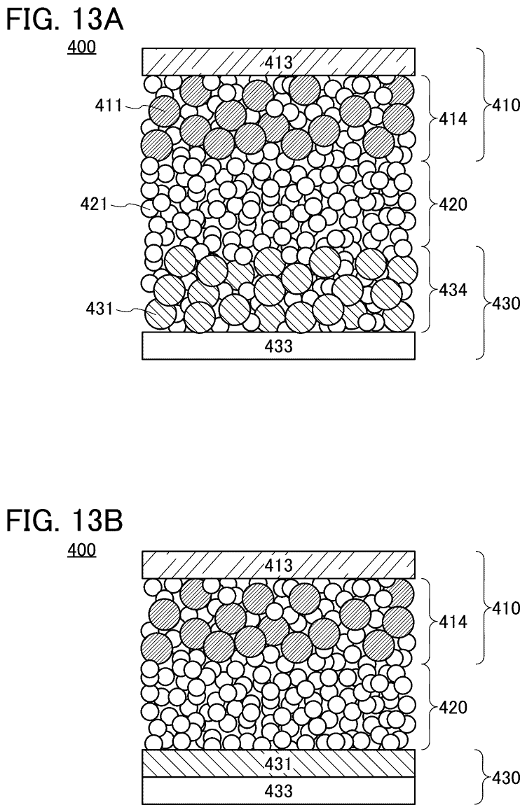

As illustrated in FIG. 13A, a positive electrode 410 of one embodiment of the present invention can be used in an all-solid-state battery that includes a solid electrolyte layer 420 and a negative electrode 430.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material manufactured by the manufacturing method described in the above embodiments is used. The positive electrode active material layer 414 may also include a conductive additive and a binding agent.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binding agent. Note that when metallic lithium is used for the negative electrode 430, the negative electrode 430 that does not include the solid electrolyte 421 can be formed, as illustrated in FIG. 13B. Metallic lithium is preferably for the negative electrode 430 to increase the energy density of a secondary battery 400.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), and sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}T_{1.46}(PO₄)₃ and Li_{1.5}Al_{0.5}Ge_{1.5}(PO₄)₃). The oxide-based solid electrolyte has an advantage such as stability in the air.

Examples of the halide-based solid electrolyte include LiAlCl₄, Li₃InBr₆, LiF, LiCl, LiBr, and LiI. Moreover, a composite material in which pores of porous aluminum oxide and/or porous silica are filled with such a halide-based solid electrolyte can be used as the solid electrolyte.

Different solid electrolytes may be mixed and used.

In particular, Li₁₊ₓAlₓTi₂₋ₓ(PO₄)₃ (0 [ x [1) having a NASICON crystal structure (hereinafter, LATP) is preferable because it contains aluminum and titanium, each of which is the element the positive electrode active material used in the secondary battery 400 of one embodiment of the present invention may contain, and thus a synergistic effect of improving the cycling performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

This embodiment can be used in combination with any of the other embodiments.

### Embodiment 7

In this embodiment, examples of the shape of a secondary battery are described.

### <Coin-Type Half Cell: Test Battery>

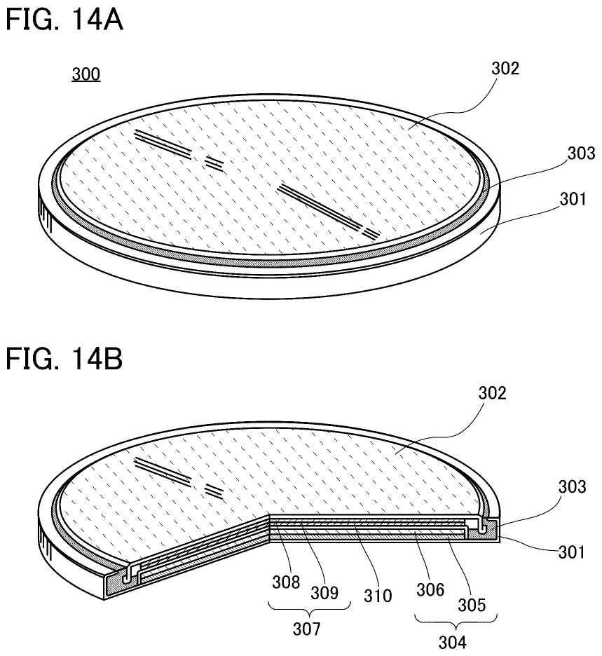

A half cell of a coin-type is sometimes referred to as a coin-type half cell. An example of a coin-type half cell is described. FIG. 14A and FIG. 14B respectively show an external view and a cross-sectional view of a coin-type half cell.

In a coin-type half cell 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that in each of the positive electrode 304 and the negative electrode 307 used for the coin-type half cell 300, only one surface of the current collector is provided with the active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, and/or the like in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and a separator 310 are soaked in the electrolyte solution. Then, as illustrated in FIG. 14B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 located therebetween. In such a manner, the coin-type half cell 300 is manufactured.

When the positive electrode active material described in the above embodiment is used in the positive electrode 304, the coin-type half cell 300 with a high discharge capacity and excellent cycling performance can be obtained.

### <<Charging Method>>

In a method for determining whether a composite oxide is the positive electrode active material 100 of one embodiment of the present invention, the above coin-type half cell is manufactured and charged and discharged.

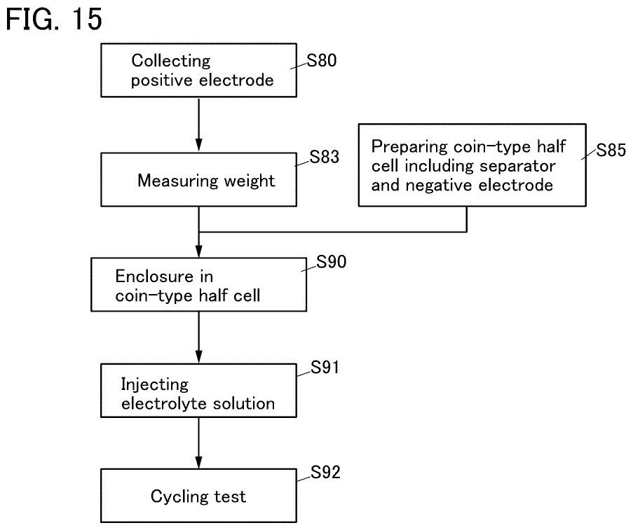

For example, as shown in Step S80 in FIG. 15, a positive electrode is taken out of a secondary battery to obtain a positive electrode active material. The positive electrode is stamped out to have a shape matching the shape of a coin-type half cell.

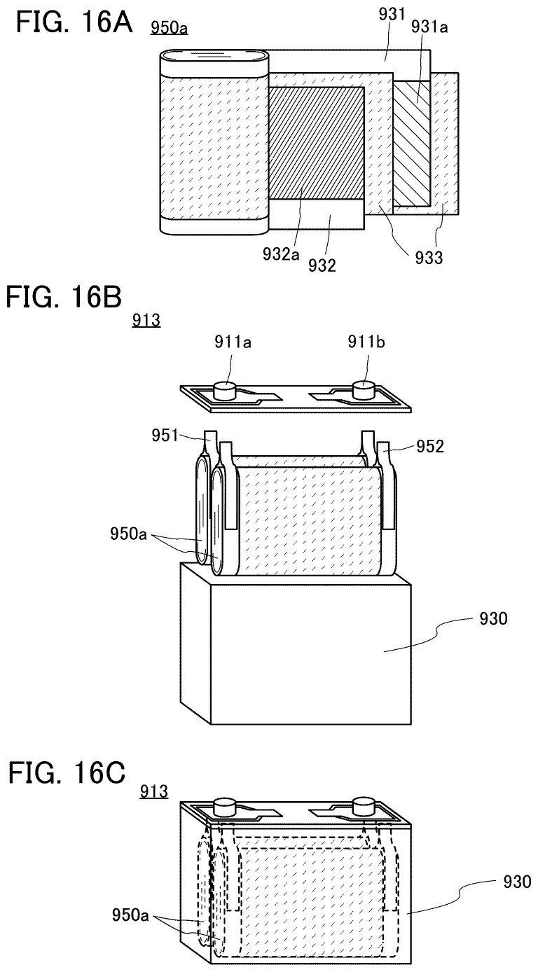

Then, as shown in Step S83 in FIG. 16, the weight of a positive electrode mixture in the stamped-out positive electrode is measured. The weight of the positive electrode is the sum of the weight of the positive electrode mixture and the weight of a positive electrode current collector. In view of this, a region of the collected positive electrode that includes only the positive electrode current collector is also stamped out to have the same shape, the weight of this region is measured. By subtracting the weight of the positive electrode current collector from the weight of the positive electrode, the weight of the positive electrode mixture having the stamped-out shape can be obtained.

Next, as shown in Step S85 in FIG. 15, a coin-type half cell that includes a separator and a negative electrode is prepared. A negative electrode of a coin-type half cell is sometimes referred to as a counter electrode, and the counter electrode can be formed using a lithium metal. Such a coin-type half cell is referred to as a test battery in some cases. The counter electrode can be formed using a material other than a lithium metal, in which case it should be noted that the potential of a secondary battery differs from the potential of a positive electrode.

As the separator, a 25-μm-thick polypropylene porous film can be used.

Then, as shown in Step S90 in FIG. 15, the stamped-out positive electrode current collector and positive electrode mixture are enclosed in the prepared coin-type half cell.

After that, as shown in Step S91 in FIG. 15, an electrolyte solution is injected. As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

Stainless steel (SUS) can be used for a positive electrode can and a negative electrode can of the coin-type half cell.

The coin-type half cell manufactured with the above conditions is subjected to constant current charging at a freely selected voltage (e.g., higher than or equal to 4.5 V) and 0.5 C and then constant voltage charging until the current value reaches 0.05 C. Note that 1 C can be 137 mA/g or 200 mA/g.

To observe a change in the positive electrode active material of the coin-type half cell, charging with a small current value is preferably performed.

The measurement temperature for the coin-type half cell or the like is higher than or equal to 0° C. and lower than or equal to 60° C., preferably higher than or equal to 25° C. and lower than or equal to 45° C. The temperature can be controlled as the temperature of a thermostatic oven in which the coin-type half cell is put.

After the charging, the coin-type half cell is disassembled in a glove box with an argon atmosphere to take out the positive electrode, so that the positive electrode active material with a large charge depth can be obtained. The first charging performed on a coin-type half cell is referred to as the initial charging in some cases. The initial charging is charging in a state where a positive electrode and the like are enclosed in an exterior body, and is distinguished from charging before the enclosure in the exterior body.

Subsequently, any of various kinds of analyses is conducted. In order to inhibit a reaction with components in the external environment during analysis, the positive electrode and the like are preferably hermetically sealed in an argon atmosphere. For example, XRD can be performed on the positive electrode and the like enclosed in an airtight container with an argon atmosphere.

This embodiment can be used in combination with any of the other embodiments.

### Embodiment 8

In this embodiment, examples of the shape of a secondary battery are described.

### <Wound Secondary Battery 2>

A wound secondary battery that is partly different from the wound secondary battery described in the above embodiment is described.

One embodiment of the present invention may be a secondary battery 913 that includes a wound body 950a as shown in FIG. 16. The wound body 950a shown in FIG. 16A includes a negative electrode 931, a positive electrode 932, and separators 933. The negative electrode 931 includes a negative electrode mixture layer 931a. The positive electrode 932 includes a positive electrode mixture layer 932a.

By including the positive electrode 932 formed using the positive electrode active material of the present invention, the secondary battery 913 can have a high capacity, a high discharge capacity, and excellent cycling performance.

The separator 933 has a larger width than the negative electrode mixture layer 931a and the positive electrode mixture layer 932a, and is wound to overlap with the negative electrode mixture layer 931a and the positive electrode mixture layer 932a. In terms of safety, the width of the negative electrode mixture layer 931a is preferably larger than that of the positive electrode mixture layer 932a. The wound body 950a having such a shape is preferable because of its high degree of safety and high productivity.

As shown in FIG. 16A and FIG. 16B, the negative electrode 931 is electrically connected to a tab 951. The tab 951 is electrically connected to a terminal 911a. The positive electrode 932 is electrically connected to a tab 952. The tab 952 is electrically connected to a terminal 911b.

As shown in FIG. 16C, the wound body 950a and an electrolyte solution are stored in an exterior body 930, whereby the secondary battery 913 is completed. The exterior body 930 is preferably provided with a safety valve, an overcurrent protection element, and the like. A safety valve is a valve to be released, in order to prevent the battery from exploding, when the pressure inside the exterior body 930 reaches a predetermined pressure.

### <Cylindrical Secondary Battery>

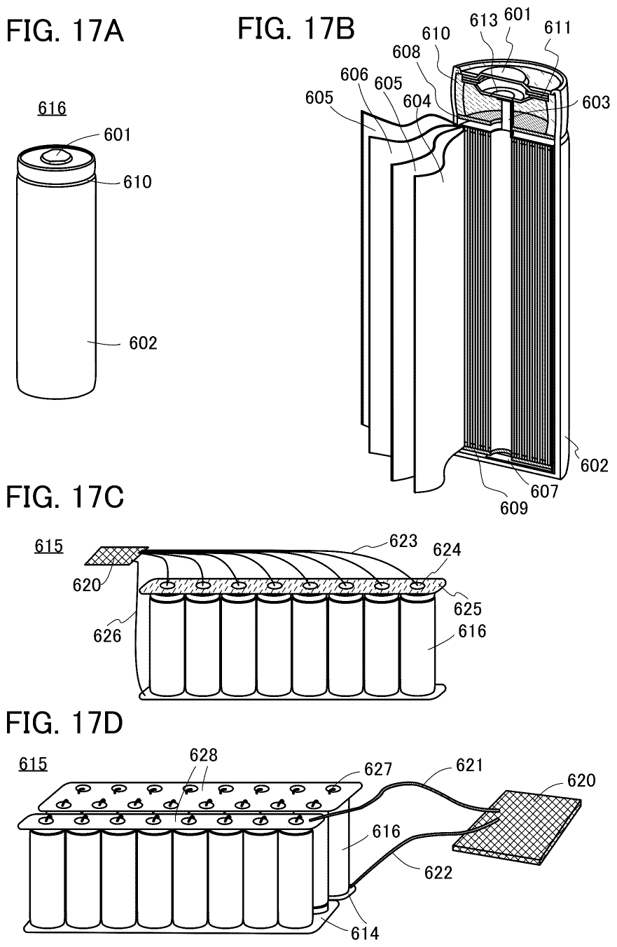

An example of a cylindrical secondary battery is described with reference to FIG. 17A. As shown in FIG. 17A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 17B schematically illustrates a cross section of a cylindrical secondary battery. The cylindrical secondary battery illustrated in FIG. 17B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-shaped positive electrode 604 and a strip-shaped negative electrode 606 are wound with a separator 605 located therebetween is provided. Although not shown, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with an electrolyte solution (not shown).

Since a positive electrode and a negative electrode that are used for a cylindrical storage battery are wound, active materials are preferably formed on both surfaces of a current collector.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 17C shows an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and overdischarging can be used.

FIG. 17D shows an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be affected by the outside temperature.

In FIG. 17D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

This embodiment can be implemented in appropriate combination with any of the other embodiments.

### Embodiment 9

In this embodiment, examples of a vehicle that includes the secondary battery of one embodiment of the present invention will be described.

The use of secondary batteries in vehicles enables production of next-generation clean energy vehicles such as hybrid electric vehicles (HVs), electric vehicles (EVs), and plug-in hybrid electric vehicles (PHVs).

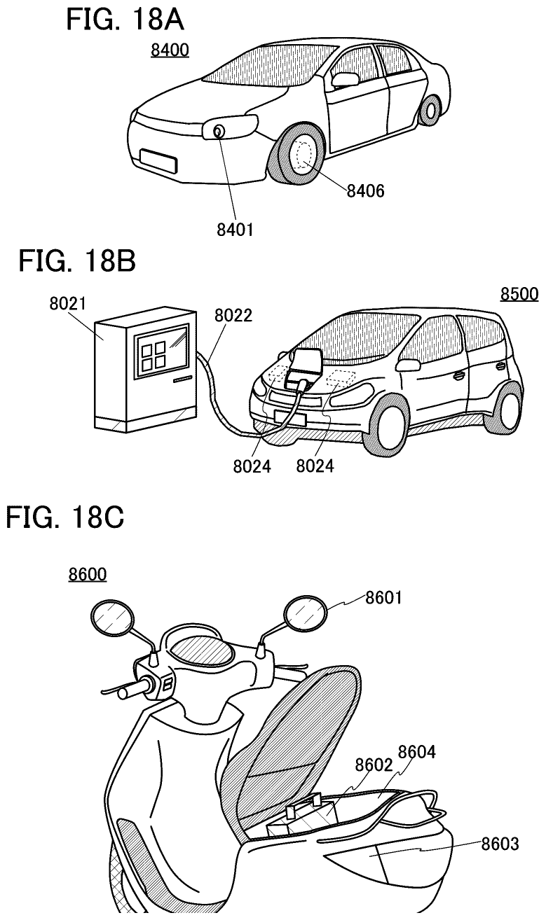

FIG. 18 illustrates examples of a vehicle including the secondary battery of one embodiment of the present invention. An automobile 8400 illustrated in FIG. 18A is an electric vehicle that runs on the power of an electric motor. Alternatively, the automobile 8400 is a hybrid electric vehicle capable of driving using either an electric motor or an engine as appropriate. The use of one embodiment of the present invention makes it possible to obtain a high-mileage vehicle. The automobile 8400 includes the secondary battery. As the secondary battery, the modules of the secondary batteries illustrated in FIG. 17C and FIG. 17D may be arranged to be used in a floor portion in the automobile. The secondary battery can be used not only for driving an electric motor 8406, but also for supplying electric power to a light-emitting device such as a headlight 8401 or a room light (not shown).

The secondary battery can also supply electric power to a display device of a speedometer, a tachometer, or the like included in the automobile 8400. Furthermore, the secondary battery can supply electric power to a semiconductor device included in the automobile 8400, such as a navigation system.

An automobile 8500 illustrated in FIG. 18B can be charged when the secondary battery included in the automobile 8500 is supplied with electric power through external charge equipment by a plug-in system, a contactless power feeding system, and/or the like. FIG. 18B illustrates a state where a secondary battery 8024 included in the automobile 8500 is charged with the use of a ground-based charging apparatus 8021 through a cable 8022. Charging can be performed as appropriate by a given method such as CHAdeMO (registered trademark) or Combined Charging System as a charging method, the standard of a connector, or the like. The charging apparatus 8021 may be a charge station provided in a commerce facility or a power supply in a house. For example, with the use of a plug-in technique, the secondary battery 8024 included in the automobile 8500 can be charged by being supplied with electric power from the outside. The charging can be performed by converting AC electric power into DC electric power through a converter such as an ACDC converter.

Although not shown, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. For supply of electric power in such a contactless manner, an electromagnetic induction method or a magnetic resonance method can be used.

FIG. 18C illustrates an example of a motorcycle that includes the secondary battery of one embodiment of the present invention. A motor scooter 8600 illustrated in FIG. 18C includes a secondary battery 8602, side mirrors 8601, and direction indicators 8603. The secondary battery 8602 can supply electric power to the direction indicators 8603.

In the motor scooter 8600 illustrated in FIG. 18C, the secondary battery 8602 can be held in an under-seat storage 8604. The secondary battery 8602 can be held in the under-seat storage 8604 even when the under-seat storage 8604 is small. The secondary battery 8602 is detachable; thus, the secondary battery 8602 is carried indoors when charged, and is stored before the motor scooter is driven.

According to one embodiment of the present invention, the secondary battery can have improved cycling performance and the discharge capacity of the secondary battery can be increased. Thus, the secondary battery itself can be made more compact and lightweight. The compact and lightweight secondary battery contributes to a reduction in the weight of a vehicle, and thus increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycling performance can be used over a long period; thus, the use amount of rare metals typified by cobalt can be reduced.

This embodiment can be implemented in appropriate combination with any of the other embodiments.

### Embodiment 10

In this embodiment, examples of electronic devices and the like each including the secondary battery of one embodiment of the present invention will be described.

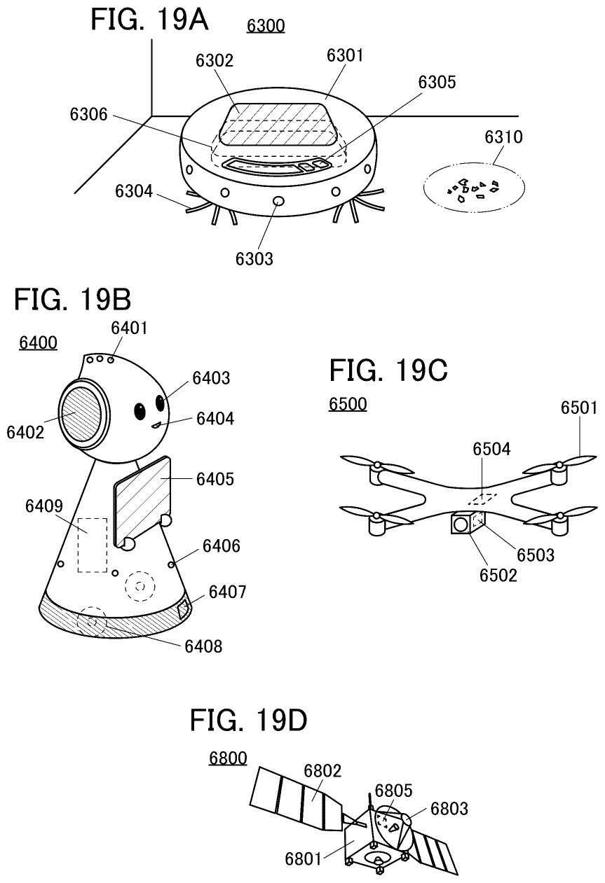

FIG. 19A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes a secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 19B illustrates an example of a robot. A robot 6400 illustrated in FIG. 19B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user with the use of the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 19C illustrates an example of a flying object. A flying object 6500 illustrated in FIG. 19C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

FIG. 19D illustrates an example of an artificial satellite 6800. The artificial satellite 6800 includes a body 6801, a solar panel 6802, an antenna 6803, and a secondary battery 6805.

When the solar panel 6802 is irradiated with sunlight, electric power required for operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for operation of the artificial satellite 6800 might not be generated. In order to drive the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can constitute a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

This embodiment can be implemented in appropriate combination with any of the other embodiments.

### Example 1

In this example, the positive electrode active material 100 of one embodiment of the present invention was manufactured and its cycling performance was obtained.

### <Manufacture of Positive Electrode Active Material>

The samples manufactured in this example are described with reference to the manufacturing method shown in FIG. 7 to FIG. 9.

As LiMO₂ in Step S14 in FIG. 7, commercially available lithium cobalt oxide (Cellseed C-10N produced by NIPPON CHEMICAL INDUSTRIAL CO., LTD.) which contained cobalt as the transition metal M and to which no additive element was added was prepared. The heating in Step S15 was performed on the lithium cobalt oxide, which was put in a crucible covered with a lid, in a muffle furnace at 850° C. for 2 hours. This heating corresponds to the initial heating. The muffle furnace was filled with an oxygen atmosphere, followed by no flowing (which corresponds to O₂ purging). The initial heating is presumed to eliminate impurities from LCO.

In accordance with Step S20a and Step S41 shown in FIG. 9A and FIG. 9B, the Mg source, the F source, the Ni source, and the Al source as the additive elements were prepared, and addition of the Mg source and the F source and addition of the Ni source and the Al source were separately performed. In accordance with Step S20a, LiF and MgF₂ were prepared as the F source and the Mg source, respectively. The LiF and MgF₂ were weighed such that LiF:MgF₂=1:3 (molar ratio). Then, the LiF and MgF₂ were mixed into dehydrated acetone and the mixture was stirred at a rotational speed of 400 rpm for 12 hours, whereby an additive element source was manufactured.

Subsequently, weighing was performed such that the sum of Mg and F of the LiF and the MgF₂ was 1 mol % with respect to cobalt of the LCO, and mixing was performed by a dry method. At this time, stirring was performed at a rotational speed of 150 rpm for 1 hour. These conditions are milder than those of the mixing of the LiF and the MgF₂: the conditions that cause no breakage of the LCO subjected to the initial heating are preferable. In this manner, Mixture A as the mixture 903 was obtained.

Then, Mixture A was heated. The heating conditions were 900° C. and 20 hours. During the heating, a lid was on the crucible containing Mixture A in a muffle furnace. The muffle furnace was filled with an oxygen atmosphere, followed by no flowing (which corresponds to O₂ purging). By the heating, LCO containing Mg and F (referred to as Composite Oxide A in some cases) was obtained.

Next, an additive element source was added to Composite Oxide A. In accordance with Step S41 shown in FIG. 9C, nickel hydroxide and aluminum hydroxide were prepared as the Ni source and the Al source, respectively. The nickel hydroxide and the aluminum hydroxide were separately stirred at a rotational speed of 400 rpm for 12 hours and ground. The Ni source, the Al source, and Composite Oxide A were weighed such that nickel in the nickel hydroxide and aluminum in the aluminum hydroxide were each 0.5 mol % with respect to cobalt in the LCO, and the Ni source, the Al source, and Composite Oxide A were mixed by a dry method. At this time, stirring was performed at a rotational speed of 150 rpm for 1 hour. These conditions are milder than those of the mixing of the nickel hydroxide and the aluminum hydroxide. The above conditions are preferably the conditions that cause no breakage of Composite Oxide A obtained. In this manner, Mixture B corresponding to the mixture 904 was obtained.

Then, Mixture B was heated. The heating conditions were 850° C. and 10 hours. During the heating, a lid was on the crucible containing Mixture B in a muffle furnace. The muffle furnace was filled with an oxygen atmosphere. Furthermore, the oxygen was prevented from entering or exiting from the muffle furnace (which corresponds to O₂ purging). O₂ purging can prevent evaporation of fluorine. By the heating, LCO containing Mg, F, Ni, and Al (referred to as Composite Oxide B in some cases) was obtained. The thus obtained LCO containing Mg, F, Ni, and Al was used as the positive electrode active material.

Next, a slurry was manufactured by mixing, at 1500 rpm, the obtained positive electrode active material (LCO), acetylene black (AB) as a conductive additive, and PVDF as a binding agent at a ratio LCO:AB:PVDF=95:3:2 (wt %). The mixing was performed using a planetary centrifugal mixer (Awatorirentaro produced by THINKY CORPORATION). As a solvent of the slurry, NMP was used. The solvent was volatilized after an aluminum current collector was coated with the slurry. The mixture on the current collector was pressed after the volatilization of the solvent.

Sample 1-1 to Sample 1-5 formed with the pressure of the above pressing varied were prepared. The table below lists the manufacturing conditions, including the pressure of the pressing.

TABLE 2

| | Conditions | | | | | | |
|---|---|---|---|---|---|---|---|
| | | | Additive | | Additive | | Pressing |
| | | Initial | element | | element | | pressure |
| | LiMO₂ | heating | source | Heating | source | Heating | (kN/m) |
| Sample 1-1 | LiCoO₂ | 850° C. | LiF | 900° C. | Ni(OH)₂ | 850° C. | No pressing |
| Sample 1-2 | | 2 hours | MgF₂ | 20 hours | Al(OH)₃ | 10 hours | 210 |
| Sample 1-3 | | | | | | | 210→461 |
| Sample 1-4 | | | | | | | 210→964 |
| Sample 1-5 | | | | | | | 210→1467 |

The loading level of the positive electrode active material was approximately 7 mg/cm² in each of Sample 1-1 to Sample 1-5.

The table below lists the electrode density (sometimes referred to as density), the electrode filling rate (sometimes referred to as filling rate), and the electrode porosity (sometimes referred to as porosity) of each of Sample 1-1 to Sample 1-5.

TABLE 3

| | Density (g/cc) | Filling rate (%) | Porosity (%) |
|---|---|---|---|
| Sample 1-1 | 2.0 | 43 | 57 |
| Sample 1-2 | 3.3 | 71 | 29 |
| Sample 1-3 | 3.7 | 79 | 21 |
| Sample 1-4 | 3.9 | 83 | 17 |
| Sample 1-5 | 4.1 | 88 | 12 |

The density was calculated from (the weight of a positive electrode mixture layer/the volume of the positive electrode mixture layer)×100, excluding the current collector of the positive electrode. The positive electrode mixture layer included the positive electrode active material, the conductive additive, and the binding agent. The filling rate was calculated from (the density/the sum of the true densities of the positive electrode active material, the conductive additive, and the binding agent)×100. The true densities of LiCoO₂, AB used as the conductive additive, and PVDF used as the binding agent were set to 5.05 g/cc, 1.95 g/cc, and 1.78 g/cc, respectively. Moreover, the porosity was calculated from (1−the filling rate)×100.

When Sample 1-1 to Sample 1-5 are compared, Sample 1-1 to Sample 1-5 are in ascending order of density and filling rate, and are in descending order of porosity as shown in Table 3.

### <Assembly of Test Battery>

Five test batteries whose positive electrodes were formed using Sample 1-1 to Sample 1-5 were assembled. The test batteries were coin-type half cells, and a lithium metal was prepared as a counter electrode, i.e., a negative electrode.

The positive electrode of each sample, the lithium metal as the negative electrode, and a separator therebetween were stored together with an electrolyte solution in a coin-type exterior body. For the separator, polypropylene was used. As the electrolyte solution, a mixture of ethylene carbonate (EC) and diethyl carbonate (DEC) at EC:DEC=3:7 (volume ratio) to which vinylene carbonate (VC) was added as an additive agent at 2 wt % was used. As an electrolyte contained in the electrolyte solution, 1 mol/L lithium hexafluorophosphate (LiPF₆) was used.

The coin-type half cells as the test batteries were assembled in this manner, and underwent cycling tests using a charge-discharge measuring instrument (TOSCAT-3100) produced by TOYO SYSTEM CO., LTD. as a charge-discharge measuring instrument. The cycling tests, i.e., evaluation of cycling performance, of the coin-type half cells make it possible to determine the performance of the positive electrodes alone (Sample 1-1 to Sample 1-5 alone) in the coin-type half cells.

### <Cycling Test>

Here, rates as the conditions of a cycling test are described. The rate at the time of discharging in a cycling test is referred to as a discharge rate and the discharge rate refers to the relative ratio of a current at the time of discharging to the battery capacity and is expressed in a unit C. A current corresponding to 1 C in a battery with a rated capacity X (Ah) is X (A). The case where discharging is performed with a current of 2X (A) is rephrased as follows: discharging is performed at 2 C. The case where discharging is performed with a current of X/2 (A) is rephrased as follows: discharging is performed at 0.5 C. The rate at the time of charging is referred to as a charge rate. The case where charging is performed with a current of 2X (A) is rephrased as follows: charging is performed at 2 C. The case where charging is performed with a current of X/2 (A) is rephrased as follows: charging is performed at 0.5 C. The charge rate and the discharge rate are collectively referred to as a charge-discharge rate in some cases. Battery characteristics obtained from cycling test results are sometimes referred to as cycling performance, and the cycling performance includes charge and discharge curves, a discharge capacity retention rate (capacity retention), and the like.

Each sample was put in a thermostatic oven at higher than or equal to 25° C. and lower than or equal to 45° C. and underwent a cycling test at a charge-discharge rate of 0.5 C, so that charge and discharge curves, the maximum discharge capacities, and discharge capacity retention rates were obtained. Specifically, constant current charging was performed at a charge rate of 0.5 C (1 C=200 mA/g) until any of three voltages of 4.60 V (referred to as 4.6 V), 4.65 V, and 4.70 V (referred to as 4.7 V) was reached, constant voltage charging was subsequently performed at each voltage until the charge rate reached 0.05 C, and constant current discharging was then performed at a discharge rate of 0.5 C until a voltage of 2.5 V was reached. Between charging and discharging, a break period longer than or equal to 5 minutes and shorter than or equal to 15 minutes may be provided and a break period of 10 minutes was provided in this example. Repetition of charging and discharging is one cycle: the number of cycles was 50.

In measurement for charging and discharging in the cycling test, a battery voltage and a current flowing in a battery are preferably measured by a four-terminal method. In charging, electrons flow from a positive electrode terminal to a negative electrode terminal through a charge-discharge measuring instrument and thus, a charge current flows from the negative electrode terminal to the positive electrode terminal through the charge-discharge measuring instrument. In discharging, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and discharge current are measured with an ammeter of the charge-discharge measuring instrument, the total amount of the current flowing during one cycle of charging and the total amount of the current flowing during one cycle of discharging are respectively a charge capacity and a discharge capacity. For example, the total amount of the discharge current flowing during the discharging in the first cycle can be regarded as the discharge capacity in the first cycle, and the total amount of the discharge current flowing during the discharging in the 50th cycle can be regarded as the discharge capacity in the 50th cycle.

In 25-° C. and 45-° C. environments, the discharge capacity of each sample was obtained with the charge voltage set to 4.6 V, 4.65 V, and 4.7 V. The highest discharge capacity is referred to as the maximum discharge capacity (mAh/g).

The table below lists the maximum discharge capacities of the samples. Note that the range of the maximum discharge capacities can be obtained from the table below.

TABLE 4
Maximum discharge capacity [mAh/g]

| | Temperature | | | | | |
|---|---|---|---|---|---|---|
| | 25° C. | | | 45° C. | | |
| Charge voltage | 4.6 V | 4.65 V | 4.7 V | 4.6 V | 4.65 V | 4.7 V |
| Sample 1-1 | 202.6 | 217.9 | 219.2 | 218.2 | 225.4 | 222.7 |
| Sample 1-2 | 208.8 | 214.9 | 216.4 | 217.2 | 224.5 | 224.9 |
| Sample 1-3 | 208.1 | 214.4 | 215.2 | 216.6 | 222.9 | 222.7 |
| Sample 1-4 | 203.5 | 212.8 | 213.7 | 217.0 | 222.8 | 224.1 |
| Sample 1-5 | 207.6 | 211.7 | 210.3 | 217.1 | 222.7 | 223.1 |

Next, the discharge capacity retention rates of the samples were obtained from the above maximum discharge capacities. For example, the discharge capacity retention rate (%) in the 50th cycle was obtained as a value calculated from (the discharge capacity in the 50th cycle/the maximum value of the discharge capacity in 50 cycles)×100, where one cycle is repetition of charging and discharging and the number of cycles was 50. The discharge capacity retention rate in the 50th cycle is the proportion of the value of the discharge capacity measured in the 50th cycle with respect to the maximum value of the discharge capacity in all the 50 cycles (which is equivalent to the maximum discharge capacity) in the case where a cycling test of 50 repetitions of a cycle of charging and discharging is conducted and the discharge capacity in each cycle is measured. In this specification and the like, the discharge capacity retention rate was calculated as the discharge capacity retention rate in the 50th cycle, unless otherwise specified.

A higher discharge capacity retention rate enables a smaller reduction in secondary battery capacity after repeated charging and discharging, which means favorable secondary battery characteristics.

The table below lists the discharge capacity retention rates. Note that the range of the discharge capacity retention rates can be obtained from the table below.

TABLE 5
Discharge capacity retention rate [%]

| | Temperature | | | | | |
|---|---|---|---|---|---|---|
| | 25° C. | | | 45° C. | | |
| Charge voltage | 4.6 V | 4.65 V | 4.7 V | 4.6 V | 4.65 V | 4.7 V |
| Sample 1-1 | 99.8 | 99.0 | 98.5 | 97.3 | 79.3 | 38.7 |
| Sample 1-2 | 99.3 | 97.9 | 95.3 | 95.4 | 70.6 | 37.3 |
| Sample 1-3 | 99.1 | 97.4 | 94.2 | 92.9 | 68.6 | 43.8 |
| Sample 1-4 | 98.7 | 96.7 | 91.8 | 91.6 | 63.0 | 42.4 |
| Sample 1-5 | 98.8 | 97.5 | 90.8 | 90.8 | 62.0 | 47.0 |

Table 5 shows that the discharge capacity retention rate after 50 cycles is higher than or equal to 35% and lower than 100% under each condition. Table 5 shows that the discharge capacity retention rate after 50 cycles is higher than or equal to 90% and lower than 100% at a measurement temperature of 25° C. under each condition.

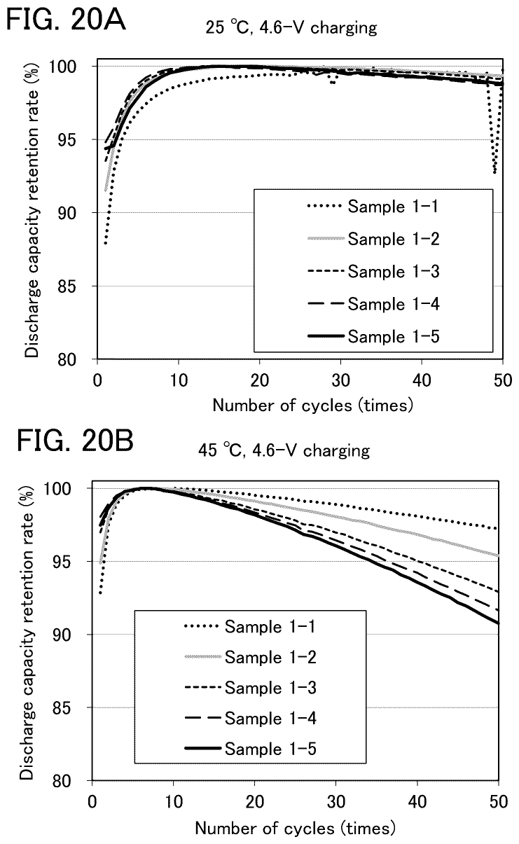

FIG. 20A to FIG. 22B are graphs showing the results of the discharge capacity retention rate at each cycle. In each graph, the X-axis represents the number of cycles (times) and the Y-axis represents discharge capacity retention rate (%). For example, the value on the Y-axis when the number of cycles on the X-axis is 50 corresponds to the discharge capacity retention rate value in Table 5 above. In the graphs showing the results of 4.65-V charging at 45° C. and those of 4.7-V charging at 45° C., the values on the Y-axis range from 30%; in the other graphs, the values on the Y-axis range from 80%. In each graph, the dashed line (short dashes) indicates the results of Sample 1-1, the light solid line indicates those of Sample 1-2, the dashed line (medium dashes) indicates those of Sample 1-3, the dashed line (long dashes) indicates those of Sample 1-4, and the dark solid line indicates those of Sample 1-5. In the blank space of each graph are legends for Samples 1-1 to 1-5.

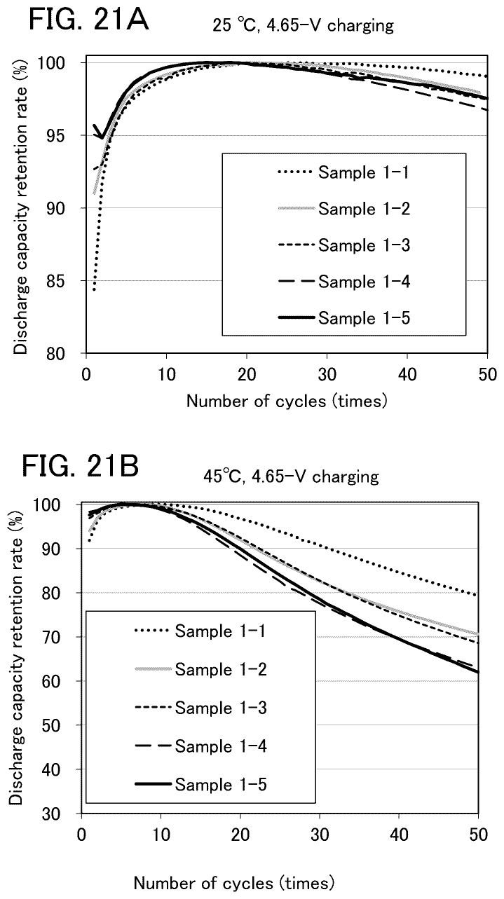

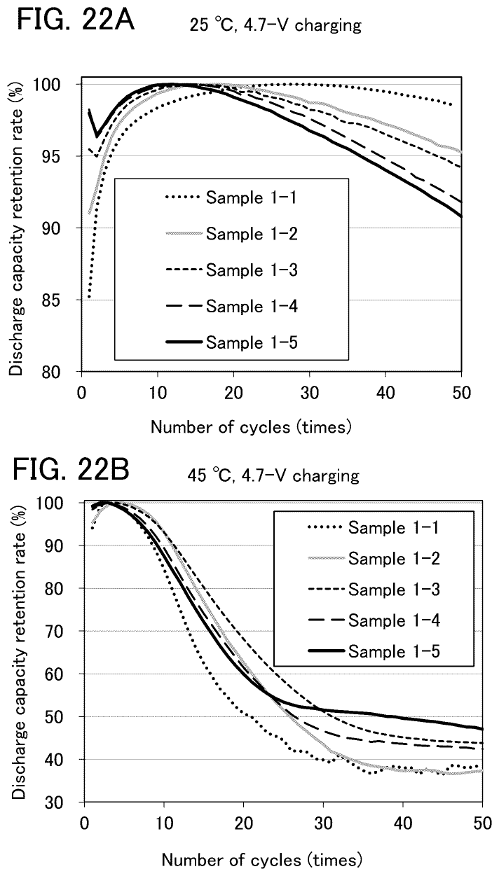

The results in FIG. 20A, FIG. 21A, and FIG. 22A show that at 25° C., the discharge capacity retention rate at each charge voltage is favorable. The results in FIG. 20B, FIG. 21B, and FIG. 22B show that at 45° C., the discharge capacity retention rate in the 50th cycle is favorable when the charge voltage is 4.6 V. From FIG. 20A to FIG. 22B, it was confirmed that the discharge capacity retention rate is dependent on the temperature; for example, it was found that the discharge capacity retention rate becomes lower when the temperature becomes higher.

To confirm the above temperature dependency, Sample 1-2 was subjected to additional cycling tests at 30° C., 35° C., and 40° C.

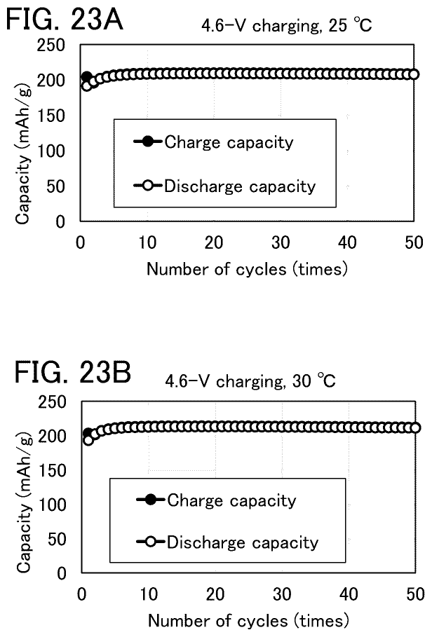

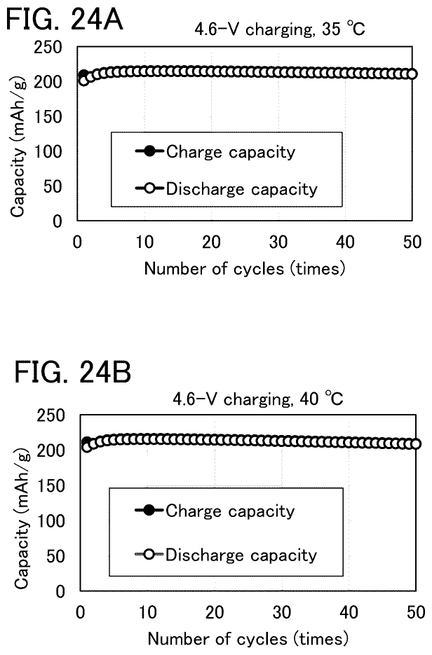

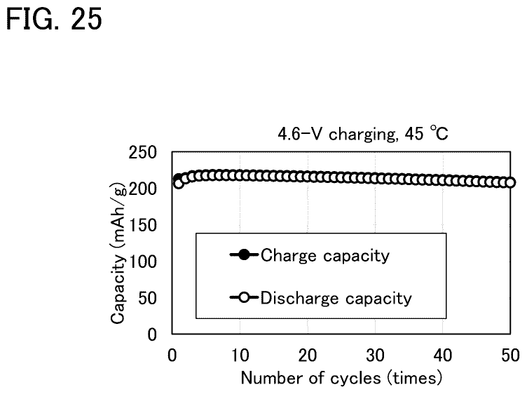

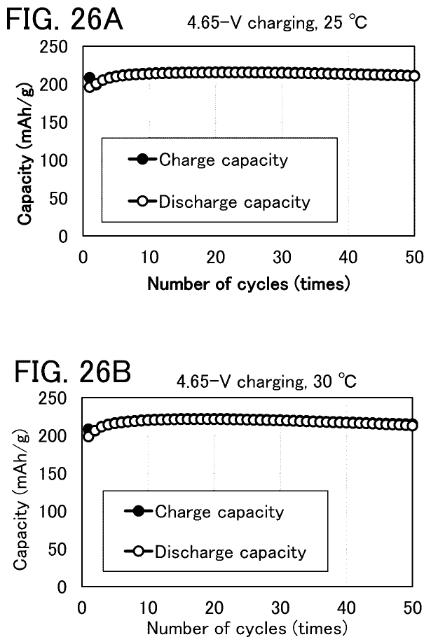

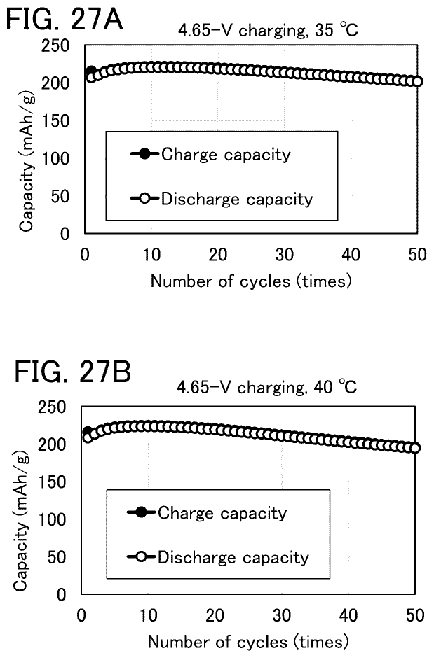

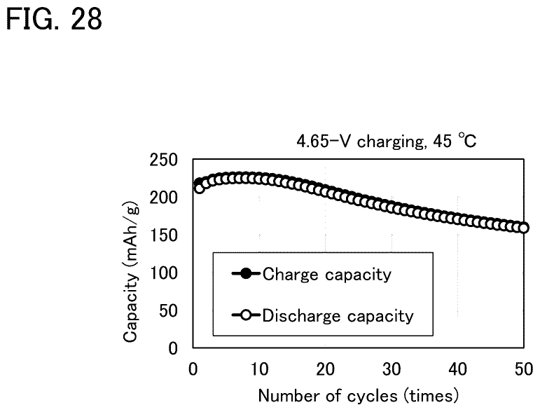

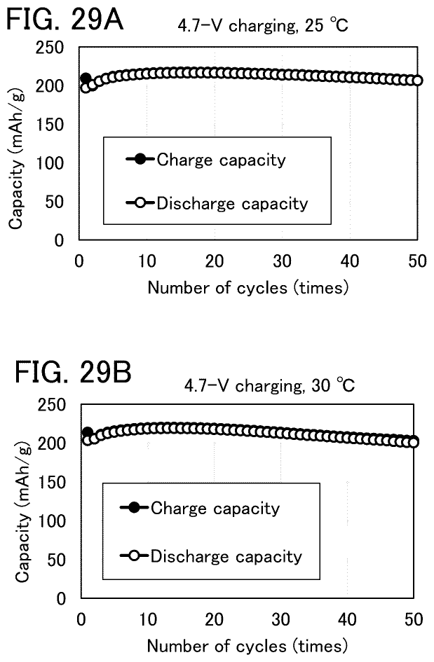

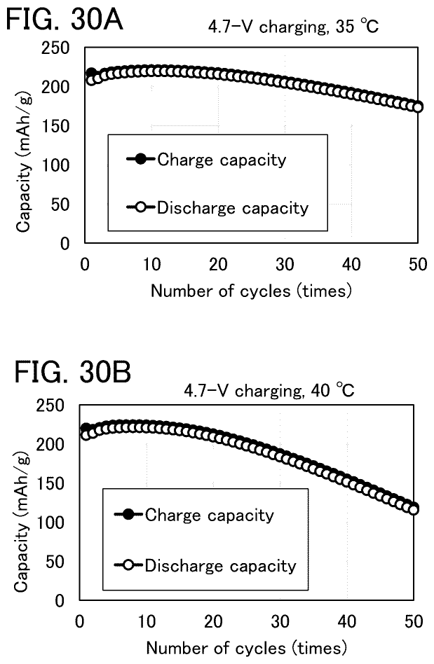

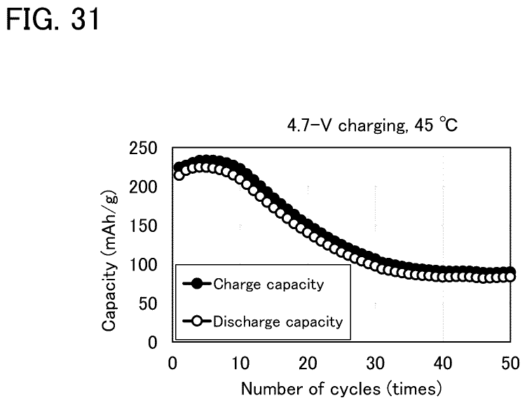

FIG. 23A to FIG. 31 show charge and discharge curves of Sample 1-2. The capacity (mAh/g) as a function of the number of cycles (times) is shown in each graph, where the X-axis represents the number of cycles (times) and the Y-axis represents two kinds of capacities, a charge capacity and a discharge capacity, which are collectively referred to as a capacity. Note that the charge capacity is the capacity required at the time of charging and is indicated by black circles in each graph, and the discharge capacity is the capacity required at the time of discharging and is indicated by white circles in each graph. The charge capacity and the discharge capacity are found to have substantially the same values.

FIG. 23A to FIG. 31 show that the capacity decreases when the measurement temperature and the number of cycles increase. It was confirmed that the charge capacity and discharge capacity, which are values of cycling performance, are dependent on the temperature. Sample 1-1 and Sample 1-3 to Sample 1-5 presumably show temperature dependency similar to that shown by the results of Sample 1-2 in FIG. 23A to FIG. 31.

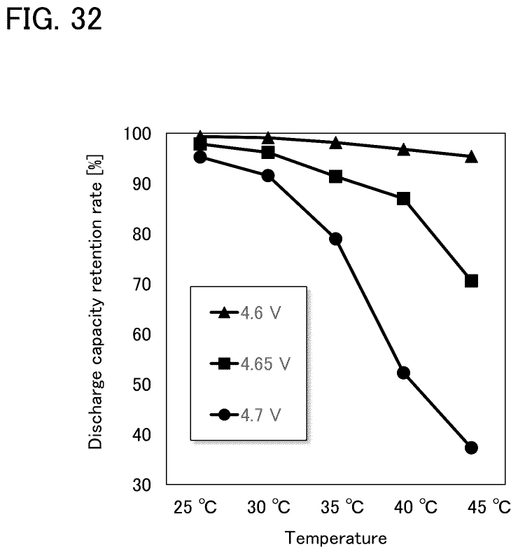

FIG. 32 is a graph showing the discharge capacity retention rate (%) of Sample 1-2 at each measurement temperature that was calculated from the charge and discharge curves in FIG. 23A to FIG. 31. In the graph, triangles indicate the results of 4.6-V charging, quadrangles indicate the results of 4.65-V charging, and circles indicate the results of 4.7-V charging. The graph shows that the discharge capacity retention rate decreases as the temperature becomes closer to 45° C. It was confirmed that the discharge capacity retention rate, which is a value of cycling performance, is dependent on the temperature. Sample 1-1 and Sample 1-3 to Sample 1-5 presumably show temperature dependency similar to that shown by the results of Sample 1-2 in FIG. 32.

The maximum discharge capacities were calculated from the charge and discharge curves in FIG. 23A to FIG. 31, the discharge capacity retention rates (%) after 50 cycles at each measurement temperature were calculated, and the table below shows the values of the discharge capacity retention rates. In the table below, the results at 25° C. and 45° C. are the same as the values of the discharge capacity retention rates shown in Table 5. Note that the range of the discharge capacity retention rates can be obtained from the table below.

TABLE 6
Discharge capacity retention rate of Sample 1-2

| Temperature | 4.6 V | 4.65 V | 4.7 V |
|---|---|---|---|
| 25° C. | 99.3 | 97.9 | 95.3 |
| 30° C. | 99.1 | 96.2 | 91.6 |
| 35° C. | 98.1 | 91.4 | 78.9 |
| 40° C. | 96.8 | 87.0 | 52.2 |
| 45° C. | 95.4 | 70.6 | 37.3 |

Table 6 shows that the discharge capacity retention rate after 50 cycles is higher than or equal to 35% and lower than 100% under each condition, or specifically under an environment at higher than or equal to 25° C. and lower than or equal to 45° C., for example. The range of the discharge capacity retention rate is the same as that shown by Table 5. In this manner, when cycling tests are performed at the upper limit of the measurement temperature and the lower limit of the measurement temperature, it is possible to determine the cycling performance, e.g., the discharge capacity retention rate, at a temperature higher than or equal to the lower limit and lower than or equal to the upper limit.

From Table 6, it is found that at lower than or equal to 30° C., the discharge capacity retention rate is higher than or equal to 90% and lower than 100% at each charge voltage. It is found that at lower than or equal to 35° C., the discharge capacity retention rate is higher than or equal to 75% and lower than 100% at each charge voltage. It is found that at lower than or equal to 40° C., the discharge capacity retention rate is higher than or equal to 50% and lower than 100% at each charge voltage. It is found that at lower than or equal to 45° C., the discharge capacity retention rate is higher than or equal to 35% and lower than 100% at each charge voltage. Setting the measurement temperature finely in this manner makes it possible to determine the cycling performance.

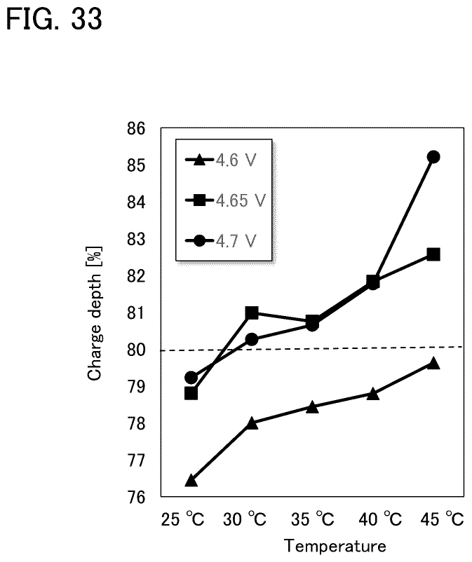

Next, the charge depth of Sample 1-2 at each measurement temperature was obtained and is shown in the graph of FIG. 33; the table below lists the values. Note that the range of the charge depths can be obtained from the table below.

TABLE 7
Charge depth (%) = (Maximum charge capacity/theoretical
capacity) × 100

| Temperature | 4.6 V | 4.65 V | 4.7 V |
|---|---|---|---|
| 25° C. | 76.5 | 78.8 | 79.2 |
| 30° C. | 78.0 | 81.0 | 80.3 |
| 35° C. | 78.4 | 80.8 | 80.7 |
| 40° C. | 78.8 | 81.8 | 81.8 |
| 45° C. | 79.6 | 82.6 | 85.2 |

Note that the charge depth can be obtained from the maximum charge capacity (that is the maximum value of the charge capacity obtained from the charge curve and the like)/theoretical capacity×100, and the theoretical capacity of LCO was set to 274 mAh/g. In FIG. 33, a dashed line is drawn to represent a charge depth of 80%, which corresponds to a charge capacity of 220 mAh/g.

By studying the charge depths taking into account the results of the discharge capacity retention rates and the like, it is found that the charge depth is greater than or equal to 80% under conditions with relatively low discharge capacity retention rates. In other words, when the charge depth is less than 80%, the discharge capacity retention rate can be high under any conditions. A charge depth of 80% corresponds to a capacity of 220 mAh/g, which is a sufficiently large capacity value. Sample 1-1 and Sample 1-3 to Sample 1-5 presumably have charge depths similar to those shown by the results of Sample 1-2 in FIG. 33.

### <Closed Split>

Cross-sectional observation was performed on Sample 1-2 and Sample 1-5 which were subjected to 4.7-V charging at 45° C. and which had relatively low discharge capacity retention rates. As shown in Table 2, Sample 1-2 was manufactured with the pressing pressure set to the lower limit, and Sample 1-5 was manufactured with the pressing pressure set to the upper limit. Note that Sample 1-2 and Sample 1-5 subjected to 4.7-V charging at 45° C. had a charge depth greater than or equal to 80%, indicating that much lithium was extracted from the positive electrode active material.

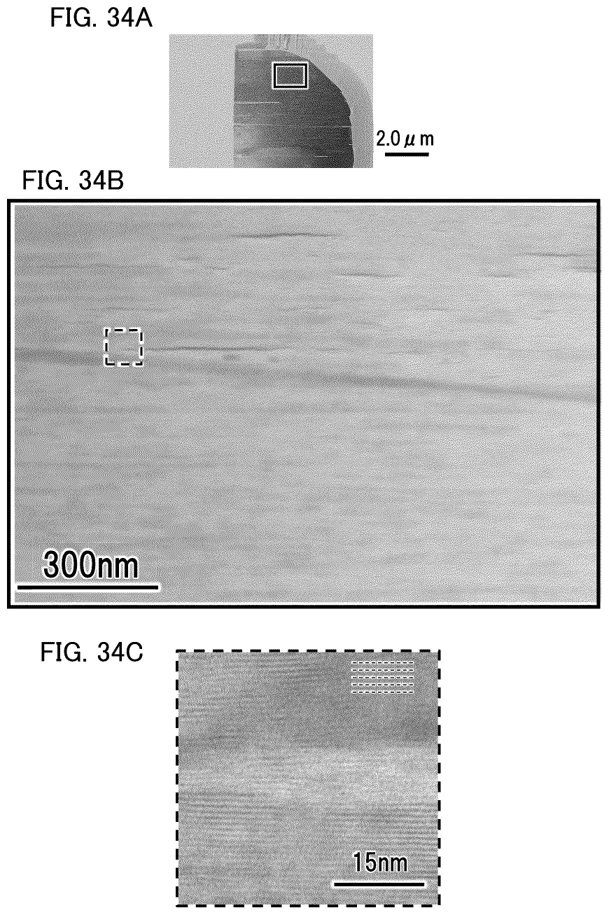

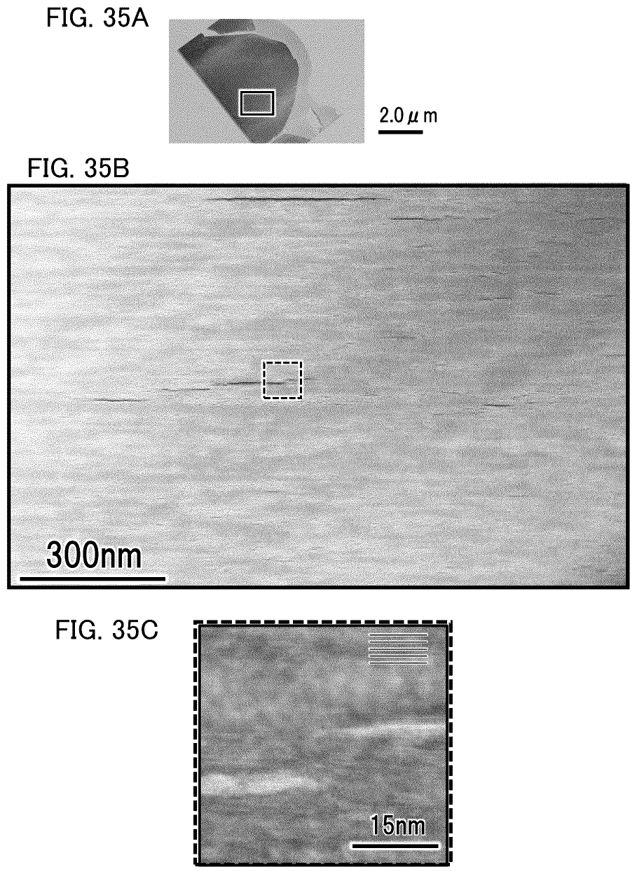

FIG. 34A shows a cross-sectional STEM image (TE image) of Sample 1-2 subjected to 4.7-V charging at 45° C., and FIG. 35A shows a cross-sectional STEM image of Sample 1-5 subjected to 4.7-V charging at 45° C. FIG. 34B and FIG. 35B are enlarged images (ZC images) of regions indicated by the solid frames in the above respective images. In the regions indicated by the dashed frames in FIG. 34B and FIG. 35B, closed splits as defects were observed. FIG. 34C and FIG. 35C are enlarged images (TE images) of regions indicated by the dashed frames in the above respective images.

In the TE images in FIG. 34C and FIG. 35C, the direction of lattice fringe corresponding to crystal planes was confirmed; thus, a plurality of solid lines indicating the lattice fringe direction were added. It is found that the closed splits had an opening along the lattice fringe direction. The opening along the lattice fringe direction is one of the reasons why it can be assumed that the closed splits were generated owing to lithium extraction.

No closed split was confirmed in the samples other than the samples subjected to 4.7-V charging at 45° C. in the cycling tests. This indicates the correlation between the presence or absence of a closed split and the charge depth or discharge capacity retention rate. For example, the charge depths of Sample 1-2 and Sample 1-5 subjected to 4.7-V charging at 45° C. exceed 80%, and it can be thus assumed that much lithium was extracted from the positive electrodes and this extraction caused the closed splits.

Next, the proportion of closed splits was analyzed with 3D visualization analysis software Amira. To make it easy to recognize a closed split in a cross-sectional STEM image, the contrast of the image is preferably adjusted. A closed split is made evident when the contrast of the closed split is adjusted to be lower. In this state, the proportion of the area of the closed split can be calculated with the use of a certain luminance of the image as the threshold value. That is, the area of a freely selected range and the area of a closed split present in this range (in the case where a plurality of closed splits are present, the sum of the areas of the closed splits) are obtained with the use of Amira, and the proportion of the closed split in a cross section of an active material (the proportion of the area of the closed split) can be calculated as a percentage.

The above is calculation of the proportion; thus, the area of the cross-sectional STEM image may be freely set. In this example, the area of the cross-sectional STEM image was set to 1.12 (0.88×1.27) μm². As the area, the area of a surface perpendicular to an electron beam of the cross-sectional STEM image is obtained in many cases; however, in the case of an image obtained with an electron beam made to be oblique, the freely set area of a surface substantially perpendicular to the electron beam is obtained. In this manner, Amira enables obtaining the proportion of the area of a closed split as the area of the closed split/the area of an image.

The proportion of the area of a closed split was 0.35% in Sample 1-2 and was 0.79% in Sample 1-5. Comparison of these values shows that a higher pressing pressure leads to a higher proportion of the area of a closed split.

When the charge depths or discharge capacity retention rates corresponding to Sample 1-2 and Sample 1-5 are taken into account, it is found that the proportion of the area of a closed split correlates with a charge depth or a discharge capacity retention rate. For a higher discharge capacity retention rate, it is preferable that there be no closed split and the proportion of the area of a closed split be lower than or equal to 0.9%.

### <Pit>

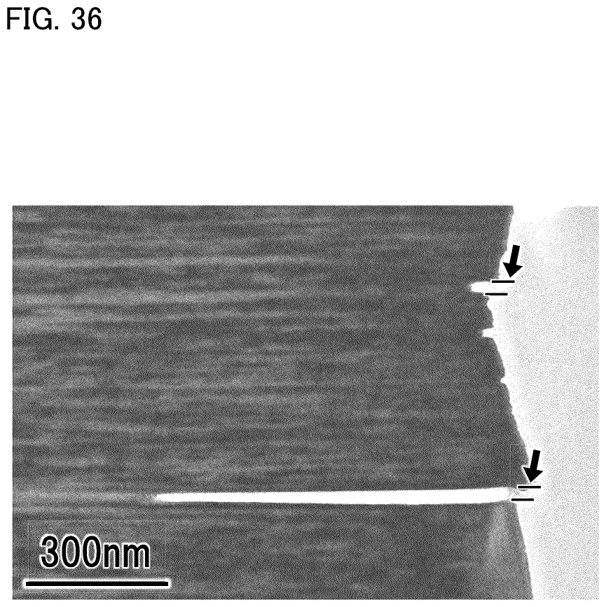

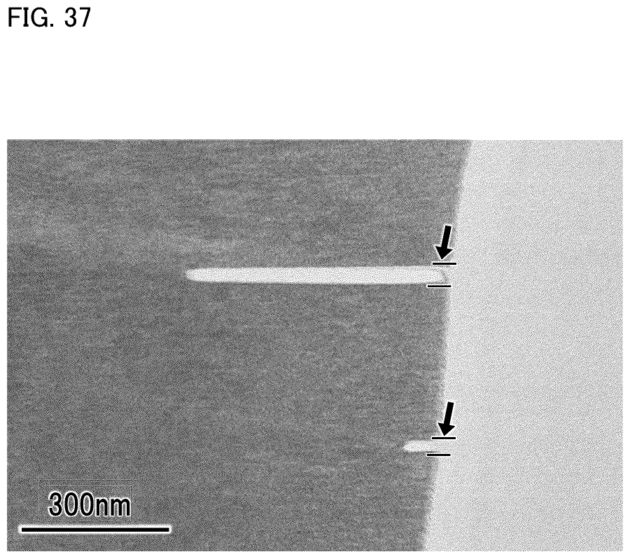

Observation of a pit was performed on Sample 1-2 and Sample 1-5 in which closed splits were observed. These samples are shown in FIG. 36 and FIG. 37, where pits are indicated with arrows.

A plurality of pits were observed in each of FIG. 36 and FIG. 37, and the states of pits were not different between Sample 1-2 and Sample 1-5. In each of Sample 1-2 and Sample 1-5, the width of a pit (the distance between the solid lines shown in each of FIG. 36 and FIG. 37) was greater than or equal to 25 nm and less than or equal to 35 nm.

### REFERENCE NUMERALS

54: pit, 55: crystal plane, 57: crack, 58: pit, 59: closed split, 100a: surface portion, 100b: inner portion, 100: positive electrode active material, 101: crystal grain boundary, 102: filling portion, 103: projection

1. A secondary battery comprising a positive electrode and a negative electrode,
wherein when a test battery comprising the positive electrode and a negative electrode, the negative electrode comprising a lithium metal, undergoes, in an environment at higher than or equal to 25° C. and lower than or equal to 45° C., a cycling test of 50 repetitions of a cycle of charging and discharging in which constant current charging is performed at a charge rate of 0.5 C until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, and a discharge capacity of the test battery is measured in each cycle, a discharge capacity value measured in the 50th cycle is greater than or equal to 35% and less than 100% of a maximum discharge capacity value in all 50 cycles, and
wherein 1 C=200 mA/g.

2-5. (canceled)

6. A secondary battery comprising a positive electrode and a negative electrode,
wherein after a test battery comprising the positive electrode and a negative electrode, the negative electrode comprising a lithium metal, undergoes, in an environment at higher than or equal to 25° C. and lower than or equal to 45° C., a cycling test of 50 repetitions of a cycle of charging and discharging in which constant current charging is performed at a charge rate of 0.5 C until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, the proportion of an area of a closed split observed by a cross-sectional STEM in one cross section of a positive electrode active material of the positive electrode is lower than or equal to 0.9%, and
wherein 1 C=200 mA/g.

7. A secondary battery comprising a positive electrode pressed under a linear pressure higher than or equal to 100 kN/m and lower than or equal to 3000 kN/m and a negative electrode,
wherein after a test battery comprising the positive electrode and a negative electrode, the negative electrode comprising a lithium metal, undergoes, in an environment at higher than or equal to 25° C. and lower than or equal to 45° C., a cycling test of 50 repetitions of a cycle of charging and discharging in which constant current charging is performed at a charge rate of 0.5 C until a voltage of 4.7 V is reached, constant voltage charging is performed until the charge rate reaches 0.05 C at a voltage of 4.7 V, and then constant current discharging is performed at a discharge rate of 0.5 C until a voltage of 2.5 V is reached, the proportion of an area of a closed split observed by a cross-sectional STEM in one cross section of a positive electrode active material of the positive electrode is lower than or equal to 0.9%, and
wherein 1 C=200 mA/g.

8-13. (canceled)

14. The secondary battery according to claim 1, wherein the positive electrode is pressed under a linear pressure higher than or equal to 100 kN/m and lower than or equal to 3000 kN/m.

15. The secondary battery according to claim 1, wherein the positive electrode has an electrode density higher than or equal to 2.5 g/cc and lower than or equal to 4.5 g/cc.

16. The secondary battery according to claim 1, wherein the positive electrode has a porosity higher than or equal to 8% and lower than or equal to 35%.

17. The secondary battery according to claim 6, wherein the test battery comprises an electrolyte solution.

18. The secondary battery according to claim 6, wherein the positive electrode comprises a layered rock-salt positive electrode active material.

19. The secondary battery according to claim 14, wherein the positive electrode has an electrode density higher than or equal to 2.5 g/cc and lower than or equal to 4.5 g/cc.

20. The secondary battery according to claim 14, wherein the test battery comprises an electrolyte solution.

21. The secondary battery according to claim 14, wherein the positive electrode comprises a layered rock-salt positive electrode active material.

22. An electronic device comprising the secondary battery according to claim 14.

23. A vehicle comprising the secondary battery according to claim 14.

24. The secondary battery according to claim 15, wherein the positive electrode has a porosity higher than or equal to 8% and lower than or equal to 35%.

25. The secondary battery according to claim 15, wherein the test battery comprises an electrolyte solution.

26. The secondary battery according to claim 15, wherein the positive electrode comprises a layered rock-salt positive electrode active material.

27. The secondary battery according to claim 16, wherein the test battery comprises an electrolyte solution.

28. The secondary battery according to claim 16, wherein the positive electrode comprises a layered rock-salt positive electrode active material.

29. The secondary battery according to claim 18, wherein the test battery is a coin-type half cell.

30. The secondary battery according to claim 19, wherein the positive electrode active material comprises lithium cobalt oxide.
